(19) United States
(12) Patent Application Publication
(10) Pub. No.: US 2013/0018696 A1
(43) Pub. Date: Jan. 17, 2013

(54) Supply Chain Analysis

(71) Applicant: Peter Fox Meldrum, Altrincham (GB)

(72) Inventor: Peter Fox Meldrum, Altrincham (GB)

(73) Assignee: EMPIRICA CONSULTING LIMITED, Altrincham (GB)

(21) Appl. No.: 13/532,549

(22) Filed: Jun. 25, 2012

Related U.S. Application Data
(60) Provisional application No. 61/504,289, filed on Jul. 4, 2011.

(51) Int. Cl. G06Q 10/06; G06Q 10/04

(52) U.S. Cl. 705/7.27; 705/348

(57) ABSTRACT

The disclosure relates to analyzing and visualizing flows in a supply chain context for the purpose of inventory optimization. Embodiments disclosed include a method of analyzing a process flow in a supply chain context, the method comprising: inputting (3402) a first set of data to an application residing on a processor, relating to products, locations and supply routes connecting the different locations in the supply chain; the application generating (3403) from the first set of data an input data array; inputting (3404) a second set of data relating to measured and forecast flows of products through the supply chain over a defined time period; the application calculating (3405) from the data a series of measures of operation of the supply chain; and, based on one or more of the measures being outside a predefined range, the application generating (3406) an output indicating recommendations for adjusting operation of the supply chain.

### FIELD OF THE INVENTION

The invention relates to analyzing and visualizing process flows in a supply chain context for the purpose of inventory optimization.

### BACKGROUND

Value Stream Mapping (VSM) is a known technique from lean manufacturing that is used for analyzing and designing production lines with the aim of optimizing inventories and reducing waste, mapping material and information flow. This optimization technique is typically locally driven, involving analysis of only one aspect of what may be a larger production system and supply chain. VSM can, however, also be used in a larger context of an entire supply chain; for example, from a starting point of a manufacturing facility through to a retail shelf.

Inventory optimization in general aims to achieve customer service targets at minimum sustainable cost; or in other words, the right amount of inventory, in the right places, to meet customer service and revenue goals. This requires vigilance and effective inventory strategies to reduce total inventory across competing supply chains, ensuring products are provided quickly at a retail location (e.g., a supermarket shelf) or other sales channel, products are available for purchase when needed (e.g., high levels of on-shelf availability), and the resulting benefits are available to all participants (e.g., manufacturer/supplier, distributor, retailer, and the ultimate consumer).

Inventory optimization, in the context of manufacturers supplying retail outlets, in general aims to achieve three goals. The first is to look at inventory levels holistically across the multiple echelons of the supply chain, maintaining shelf availability at or above a desired level, typically greater than 95%. In other words, a particular product should be available for purchase at a retail facility for 95% or more of the time during any given period. The second goal is to maintain inventory levels through the supply chain within optimum bands while achieving this target (or optimum) shelf availability under all foreseeable variations;

while taking into account the impact of upstream and downstream inventory and many other factors such as lead time, ordering and logistics costs, prices, postponement of final product assembly, demand patterns and other characteristics of the supply chain. The third goal is to account for the impact of variability in demand or supply in setting inventory levels, maintaining and updating safety stock appropriately across the echelons.

VSM can be used to identify ‘hot spots’ in a supply chain; for example, points in the supply chain that may be causing bottlenecks and limiting the ability of the whole chain from performing optimally under varying conditions. Once such a hot spot is identified, remedial action can be taken, which might for example be to look in more detail at a particular facility to see whether the bottleneck can be removed. A specific example may be using VSM to identify a bottleneck at a warehousing facility, which then leads to a finding that the bottleneck could be removed by the simple matter of providing another doorway to allow materials to pass more quickly. Such solutions may be obvious once identified but may be difficult to identify, particularly if the supply chain is complicated.

Analyzing a supply chain using VSM can become a complex problem involving multiple conflicting criteria across competing organizations in a given supply chain. Inventory control is an inherently dynamic process that also has to take into account changing business objectives such as promotional events, which will affect sales of a product while such an event is active.

Supply chains may have multiple paths between a manufacturing facility and a retail facility. As an example, multiple warehouses may be provided in the supply chain in order to deal with parallel streams of fast moving and slower moving products. Parallel streams may also be present within a single supply chain, for example due to different product characteristics. For example, certain products such as aerosols have different handling requirements from other products such as detergents, due to safety issues relating to pressurized containers. Analysis of the supply chain using conventional methods, which tends to lump together all products in a supply chain, might not thereby identify bottlenecks present that relate to some but not all of the products in the chain.

A further problem with existing methods is that of handling forecasting of stocking requirements. Inaccurate forecasting can lead to over-stocking or under-stocking of products, both of which lead to inefficiencies in the supply chain. Under-stocking can result in loss of sales, for example a known forthcoming promotion not being taken properly into account, resulting in shelf availability for the promoted product falling below an optimum level and a resulting loss of sales. End-to-end supply chains therefore typically involve complexity and uncertainty, due to their multi-dimensional and inter-dependent nature.

As part of a typical VSM implementation, a visualization of a process is created; typically a manufacturing process. This allows data that would otherwise be largely impenetrable to be made clearer so that hot spots can be identified. Visualization methods may include generating a map indicating locations connected by supply routes, the locations representing facilities for manufacturing, storage, distribution and retail. Links between the locations represent the supply routes. A further visualization of the supply chain may be in the form of a timeline, which represents the various times involved in each process from manufacture to retail as materials flow through the chain. From these visualizations, points in the supply chain can be identified that may be causing problems, and these can be investigated further.

Analysis of a supply chain using conventional methods tends to over-simplify and over-aggregate the details of the supply chain, which results in the prescription of only a limited range of solutions or fails to identify important issues affecting overall business performance. On the other hand, visualization methods within the ‘lean manufacturing movement’ such as Value Stream Mapping, which represents the flows within production and the timing and value added elements of the process, introduce more detail within a narrow scope, giving good visibility to non-value added activities (hot spots), and approaches for reducing waste. Lean manufacturing approaches generally interpret inventory as waste, which is not always appropriate; for example, in FMCG (Fast-Moving Consumer Goods) supply chains, a certain level of inventory is often required for a supply chain to operate effectively.

There is therefore a need for an improved method for analyzing supply chains for the purpose of inventory optimization.

### SUMMARY OF THE INVENTION

In accordance with a first aspect of the invention there is provided a method of analyzing a process flow in a supply chain context, the method comprising:
inputting a first set of data to an application residing on a processor, the first set of data relating to a plurality of different products, a plurality of different locations and a plurality of supply routes connecting the different locations in the supply chain along which the plurality of products are distributed;
the application generating from the first set of data an input data array having dimensions corresponding to the plurality of products, locations and supply routes;
inputting into the input data array a second set of data relating to measured and forecast flows of the different products through the supply chain over a defined time period;
the application calculating from the second set of data a series of measures of operation of the supply chain; and
based on one or more of the series of measures being outside a predefined range, the application generating an output indicating recommendations for adjusting operation of the supply chain.

The plurality of different products is preferably a subset of an entire range of products distributed in the supply chain. This makes the invention simpler to operate and requires less data input, while maintaining a representative overview of the operation of the supply chain in question. The plurality of products may be selected from the entire range on the basis of representing a range of different types of products having distinct characteristics, for example products that may need to pass through different processes in the supply chain. The plurality of products may be randomly selected; for example, using a statistical technique such as stratified random sampling.

The invention aims to provide a more efficient way of analyzing the complexity of a real supply chain, preferably without having to reference every product within a portfolio, in order to make visible a full range of interdependent issues in the way inventory is being managed and controlled in the end-to-end supply chain. An additional aim is to allow a non-specialist user to efficiently analyze the dynamic control of the inventory, because once the data is input the method performs calculations that result in output recommendations rather than merely data analysis. The recommendations can then be used by a relatively less skilled person (for example compared to a person sufficiently skilled to fully understand the way in which the calculations are performed) to carry out certain tasks relating to testing and improving operation of the supply chain.

The series of measures may include for each of the plurality of different products at each of the plurality of different locations one or more of:
a measure of volatility in demand;
a measure of average inventory;
a measure of forecast accuracy; and
a measure of forecast bias.

The series of measures optionally take into account the effect of including one or more events within the defined time period. The one or more events may for example comprise a promotional event relating to one or more of the plurality of products. Taking into account such events allows the output of the method to be more readily understood in relation to the normal operation of the supply chain. For example, by comparing the output of the method when considering all of the input data with only a part of the input data relating to periods in which events occur, the disruptive effect of events can be accounted for.

The application may perform analysis of the second set of data for each of the plurality of locations and output a customized recommendation relating to any of the series of measures being outside a predefined bound for each location.

The application may output a customized recommendation relating to one or more of:
an inventory level for one or more of the products being above a defined threshold for the defined period;
a service level for one or more of the products being below a defined threshold for the defined period;
a level of shelf availability for one or more of the products being below a defined threshold; and
a level of responsiveness for one or more of the products being delivered at the optimum threshold.

The application may output one or more potential causes for the series of measures being outside the predefined bound.

The customized recommendation may comprise a predefined checklist specific to an associated measure being outside the defined bound.

In accordance with a second aspect of the invention there is provided a method of analyzing a process flow in a supply chain context, the supply chain comprising a plurality of different products flowing between a plurality of different locations connected by a plurality of supply routes, the method comprising:
inputting a set of data to an application residing on a processor, the set of data relating to measured and forecast flows of the different products through the supply chain over a defined time period;
the application calculating from the input set of data a series of measures of operation of the supply chain; and
based on one or more of the series of measures being outside a predefined range, the application generating an output indicating recommendations for adjusting operation of the supply chain.

In accordance with a third aspect of the invention there is provided a method of visualizing a process flow in a supply chain context, the method comprising:
providing data relating to a plurality of different products in the supply chain, the data relating to inventory levels and process flow timings associated with a plurality of locations in the supply chain;
selecting one of the plurality of different products; and
generating a graphical representation of data relating to the selected product, the graphical representation comprising a timeline indicating the inventory levels and process timings for the selected product at each of the plurality of locations in the supply chain.

The step of providing data may comprise sampling product data from a larger data set representing a product portfolio.

The supply chain may include a plurality of parallel processes, the inventory levels and process timings for each of the parallel processes being displayed in the graphical representation.

The step of providing data may comprise taking a sample of data relating to the plurality of products in the supply chain.

The method may comprise generating a report relating to the sample of data, wherein entries in the report are indicated relative to a predefined range. Entries in the report outside a predefined range may be highlighted.

The method may comprise presenting a graphical representation of inventory levels for one or more of the plurality of locations in the supply chain over a defined sampling period. The graphical representation may also indicate predefined maximum and/or minimum inventory levels.

In accordance with a fourth aspect of the invention there is provided a system for analyzing a process flow in a supply chain context, the system comprising an application residing on a processor and a memory, the system comprising:
a first input data array having a first set of data relating to a plurality of different products, a plurality of different locations and a plurality of supply routes connecting the different locations in the supply chain along which the plurality of products are distributed;
a data array generator configured to generate from the first set of data a second input data array having dimensions corresponding to the plurality of products, locations and supply routes in the first set of data; and
a calculating module configured to input into the second input data array a second set of data relating to measured and forecast flows of the different products through the supply chain over a defined time period, calculate from the second set of data a series of measures of operation of the supply chain and, based on one or more of the series of measures being outside a predefined range, generate an output indicating recommendations for adjusting operation of the supply chain.

### DETAILED DESCRIPTION

Aspects and embodiments of the invention are described in further detail below by way of example and with reference to the enclosed drawings in which:

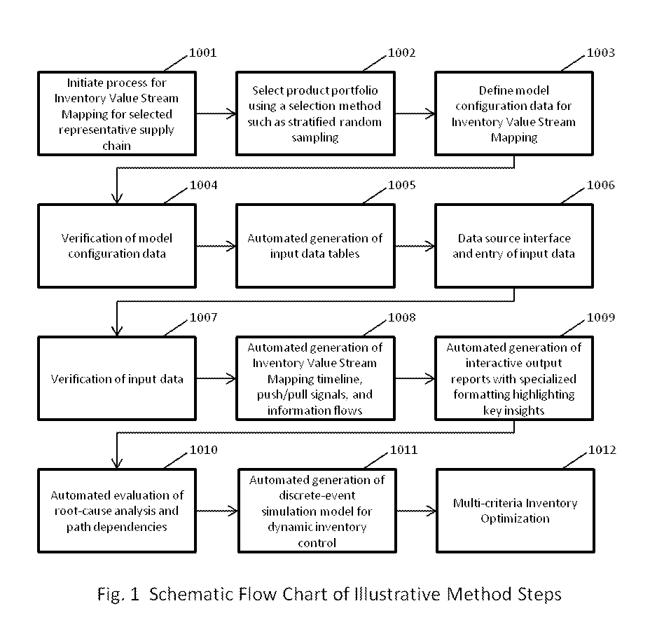

FIG. 1 is a schematic flow chart of illustrative method steps;

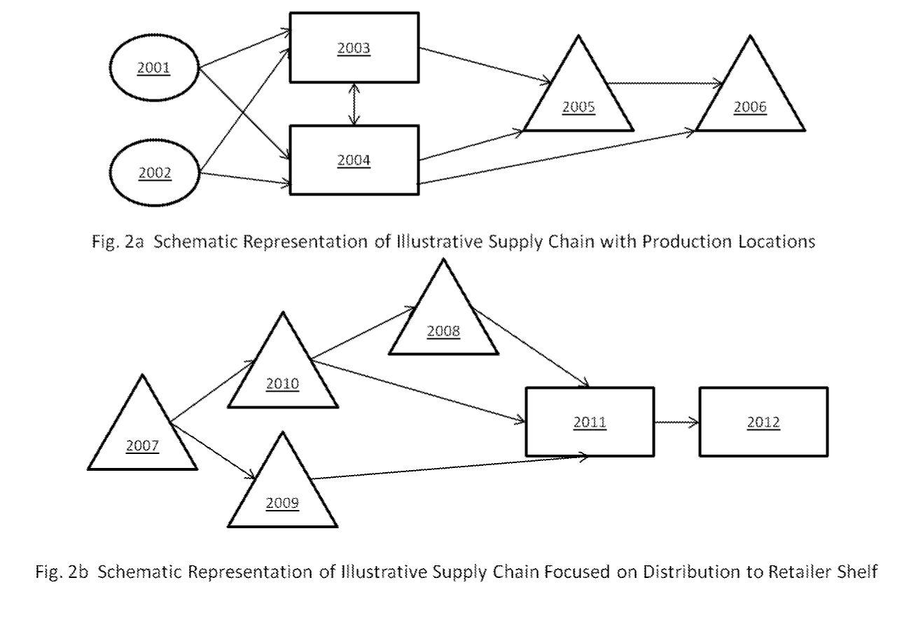

FIGS. 2a and 2b are schematic representations of illustrative supply chains;

FIG. 3 is a table containing definitions of a selected subset of a product portfolio for an exemplary supply chain;

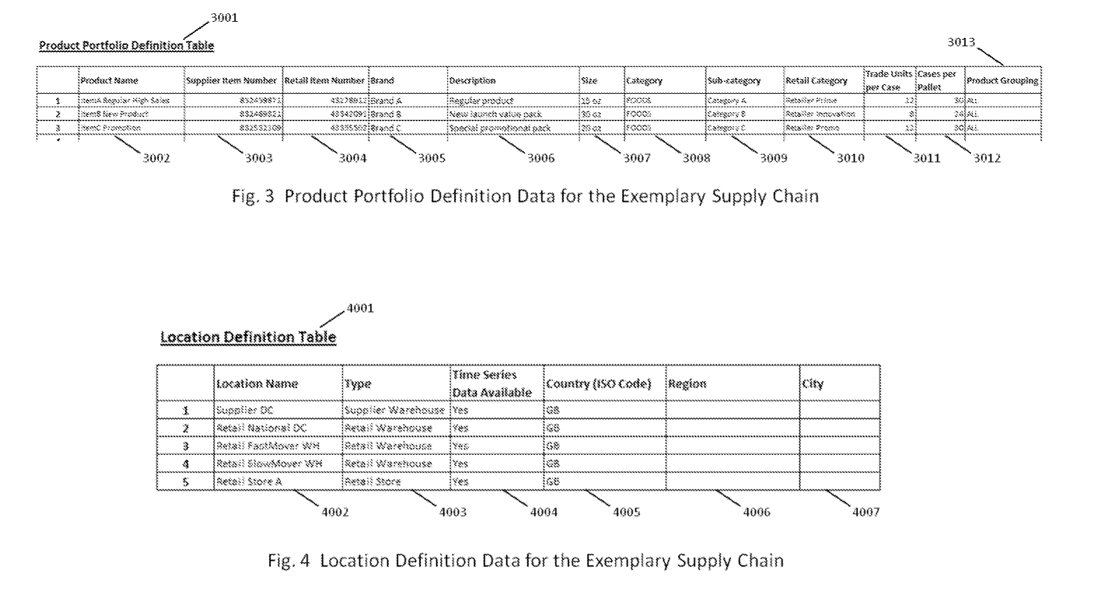

FIG. 4 is a table containing definitions of locations for the exemplary supply chain;

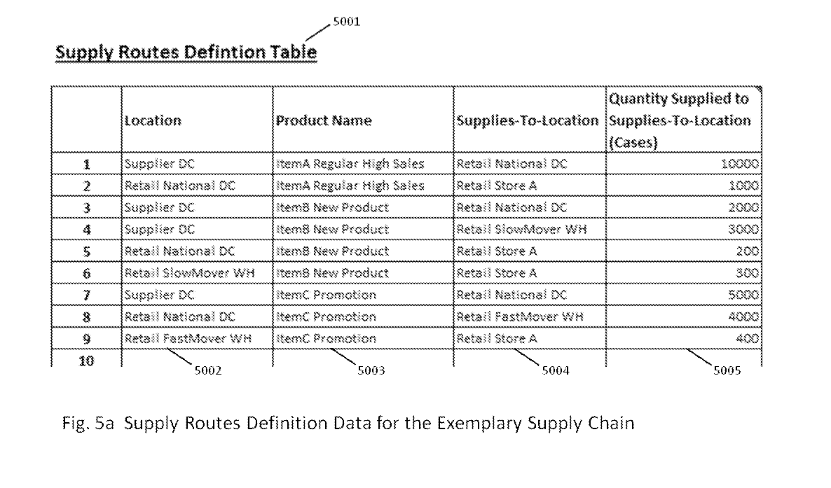

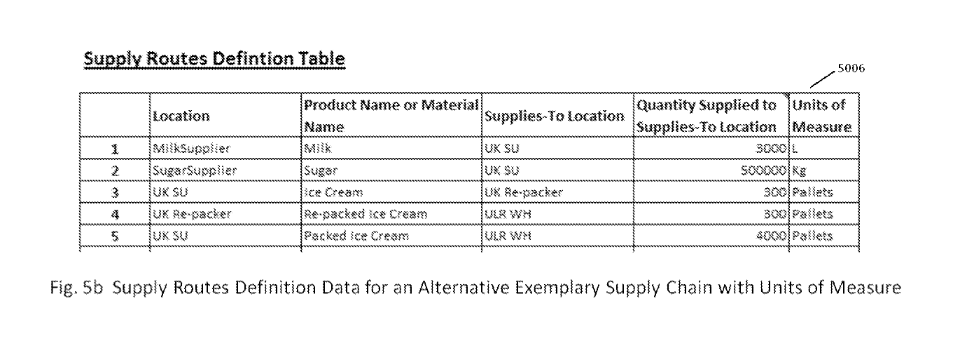

FIGS. 5a and 5b are tables containing definitions of supply routes between each of the locations in the exemplary supply chain, FIG. 5b is a similar table, but with units of measure;

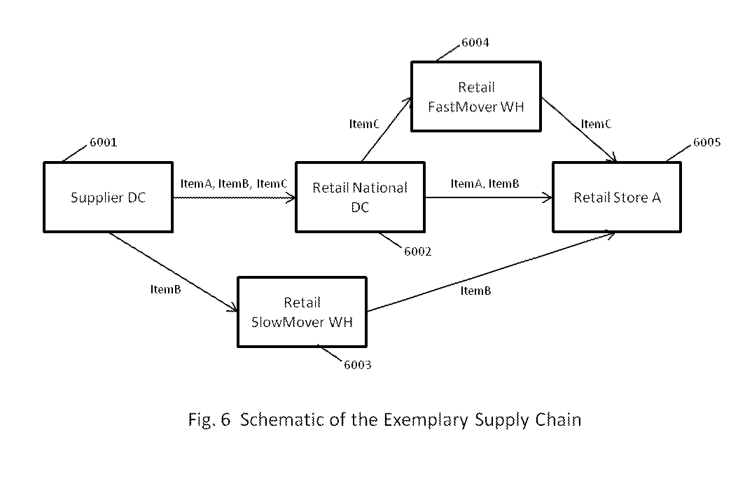

FIG. 6 is a schematic representation of the exemplary supply chain;

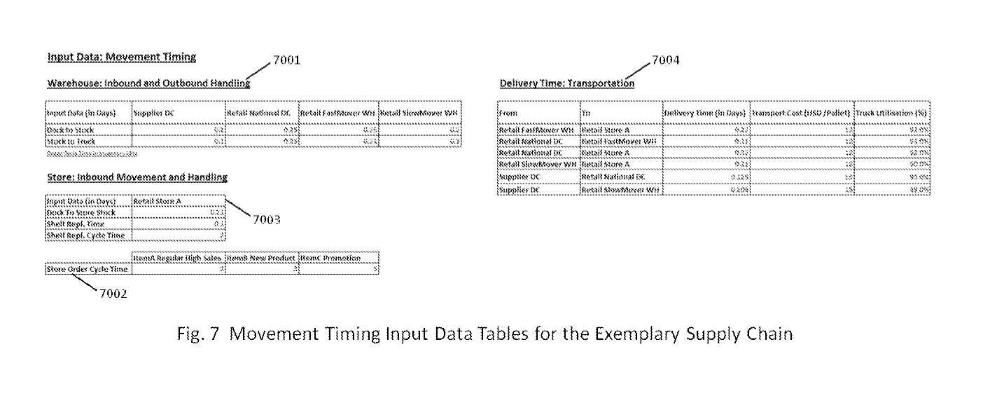

FIG. 7 shows various tables containing input data relating to movement timing and order cycle times for the exemplary supply chain;

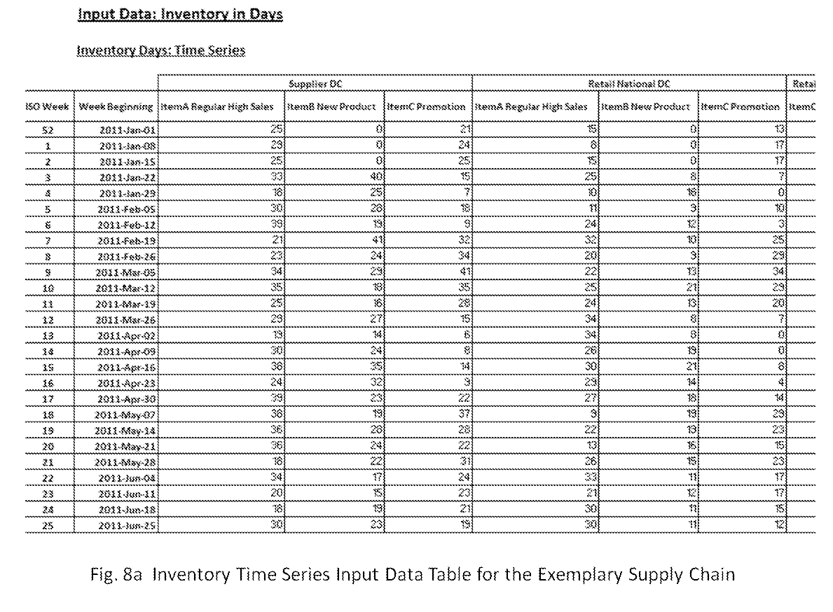

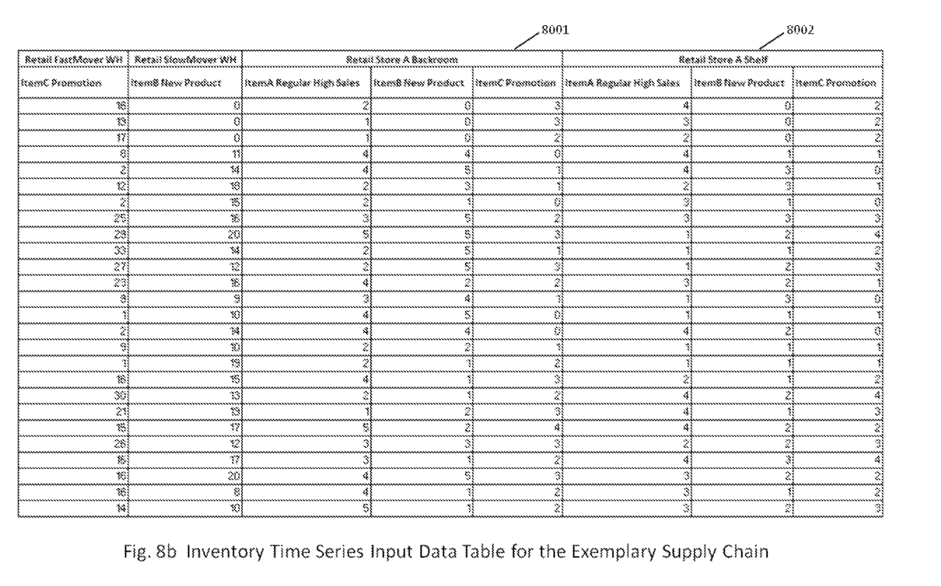

FIGS. 8a and 8b show tables containing input data relating to inventory over a defined period;

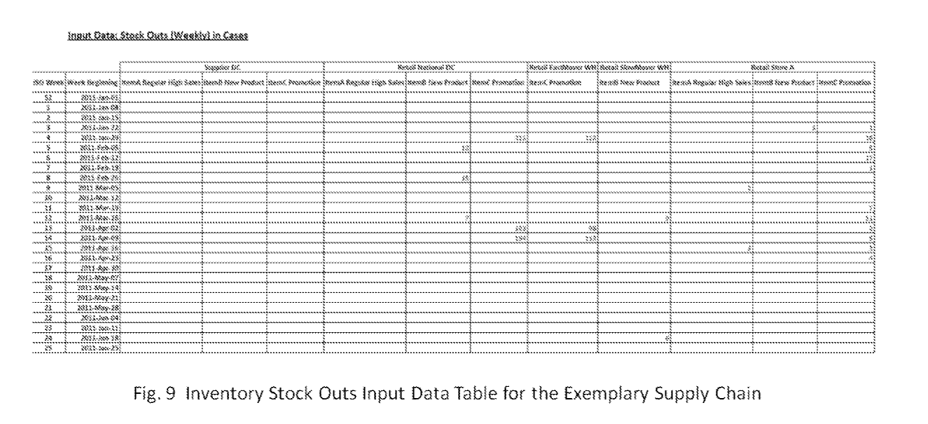

FIG. 9 is a table containing input data relating to stock outs over the defined period;

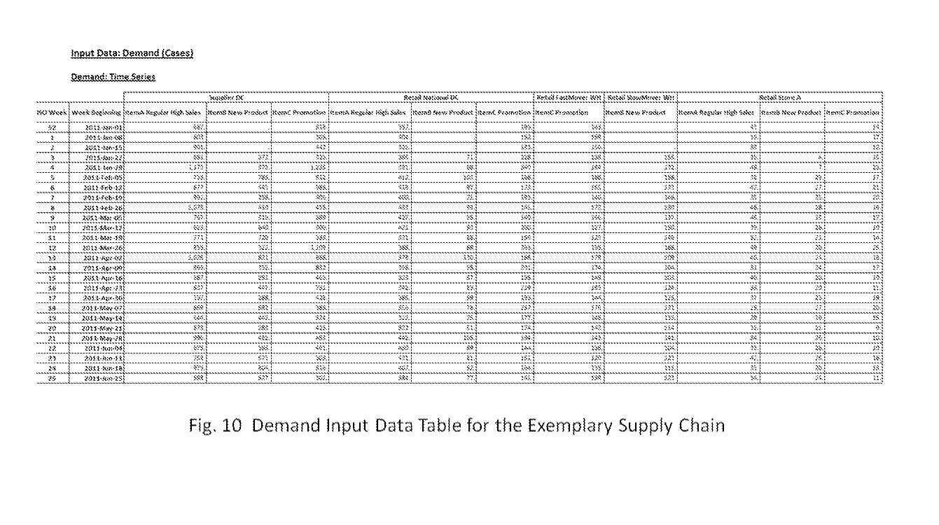

FIG. 10 is a table containing input data relating to demand over a defined period for each of the locations in the exemplary supply chain;

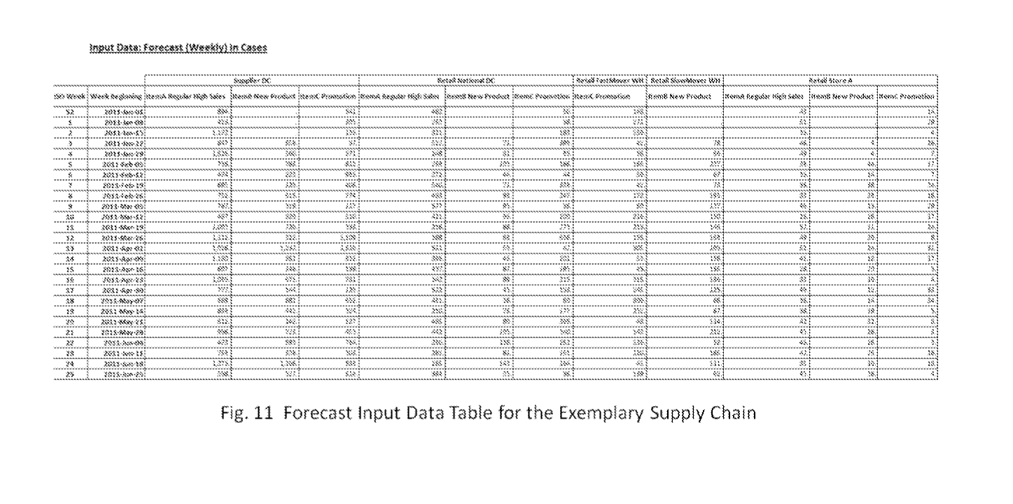

FIG. 11 is a table containing input data relating to demand forecasts over the defined period for the exemplary supply chain;

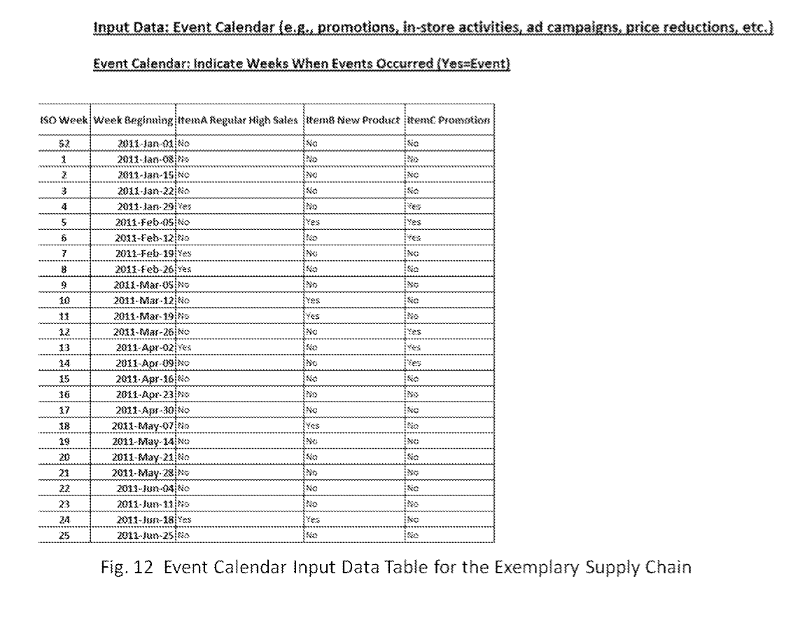

FIG. 12 is a table containing input data indicating when events occur for each product over the defined period;

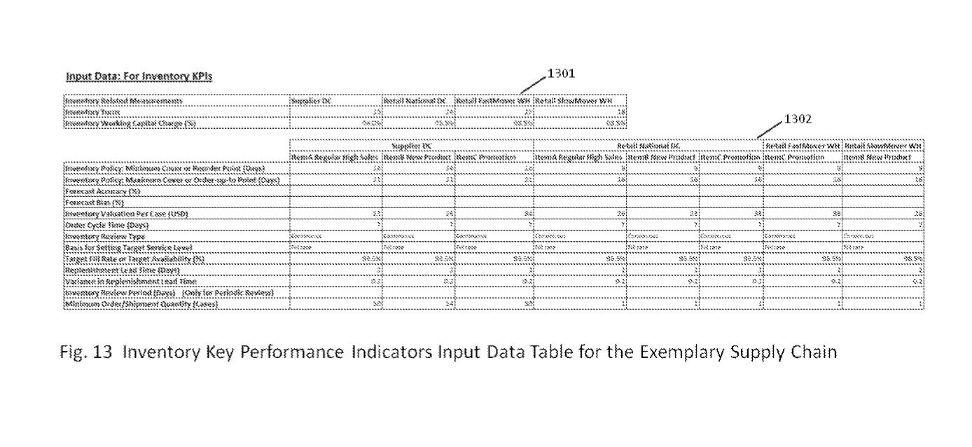

FIG. 13 shows tables containing input data for inventory key performance indicators for each location and product in the supply chain;

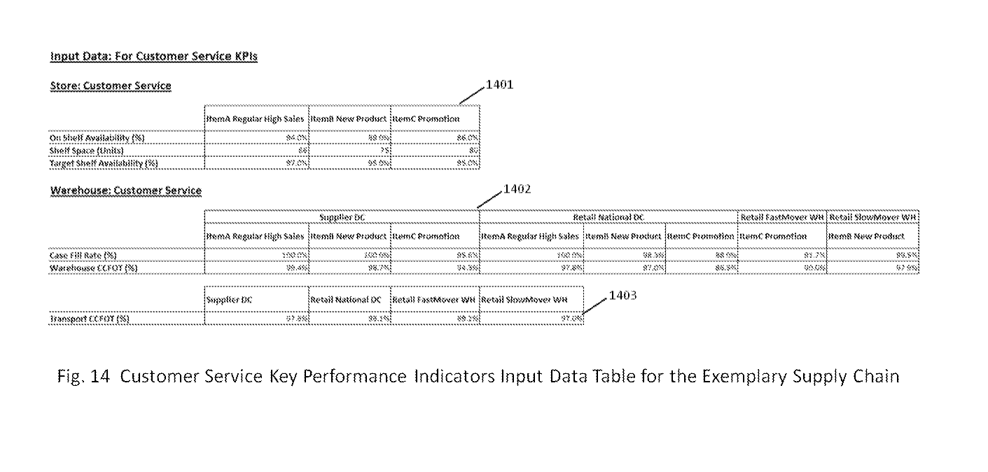

FIG. 14 shows tables containing input data relating to customer service key performance indicators;

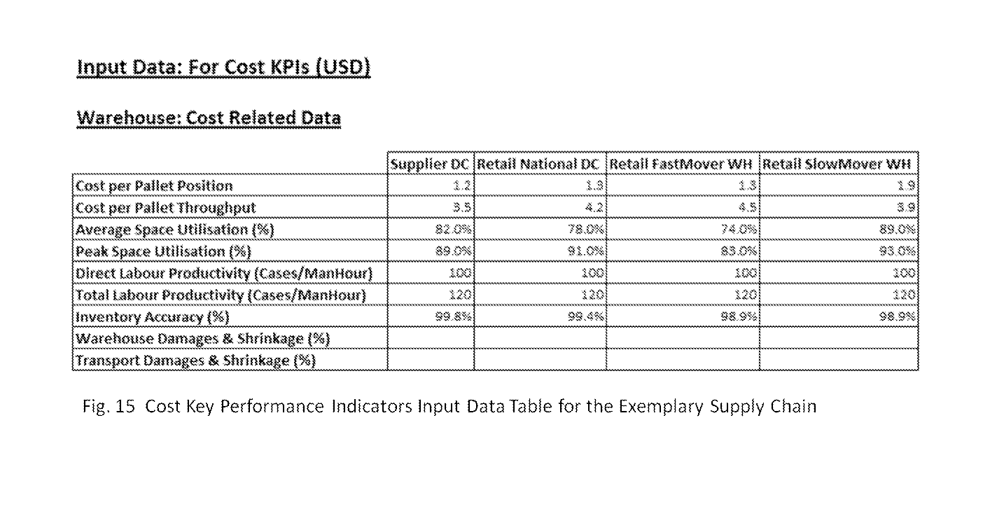

FIG. 15 is a table containing input data relating to warehouse costs;

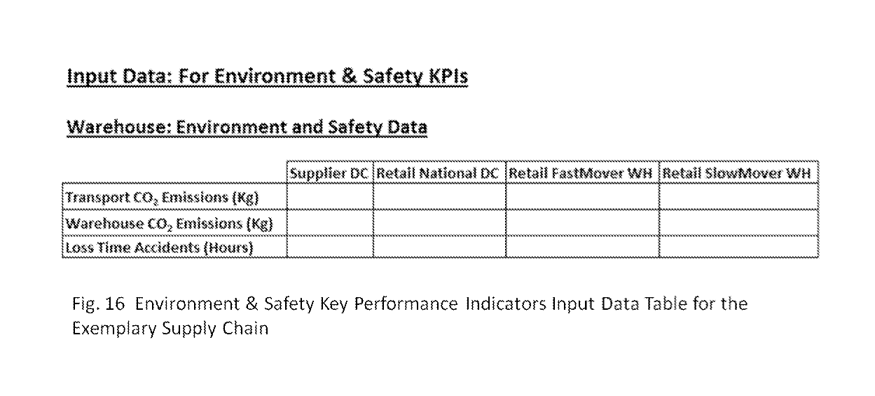

FIG. 16 is a table containing input data relating to environment and safety key performance indicators;

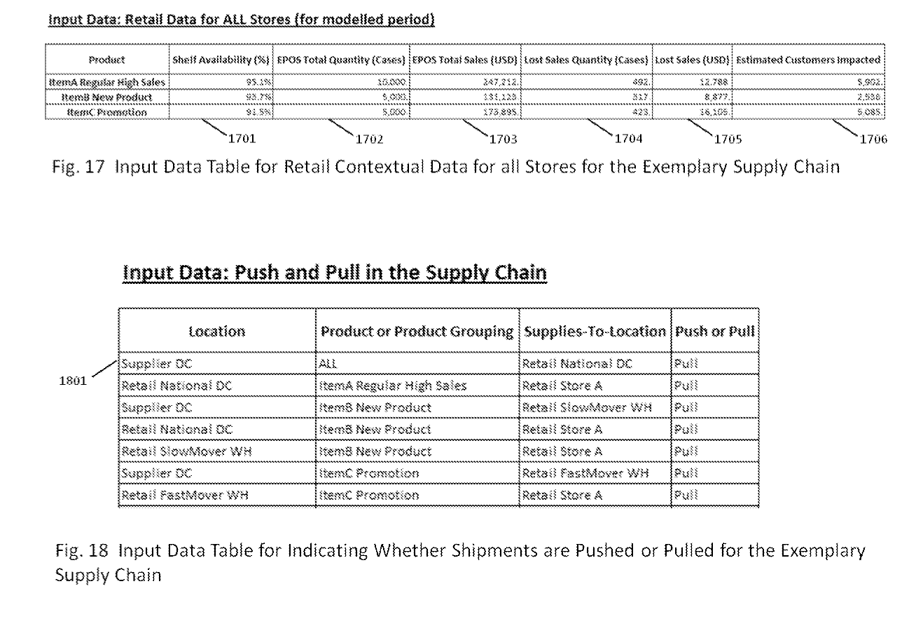

FIG. 17 is a table containing input data for retail context for all stores (from a particular retailer) being served by the exemplary supply chain;

FIG. 18 shows a table for input data indicating when shipments are pushed or pulled for the exemplary supply chain;

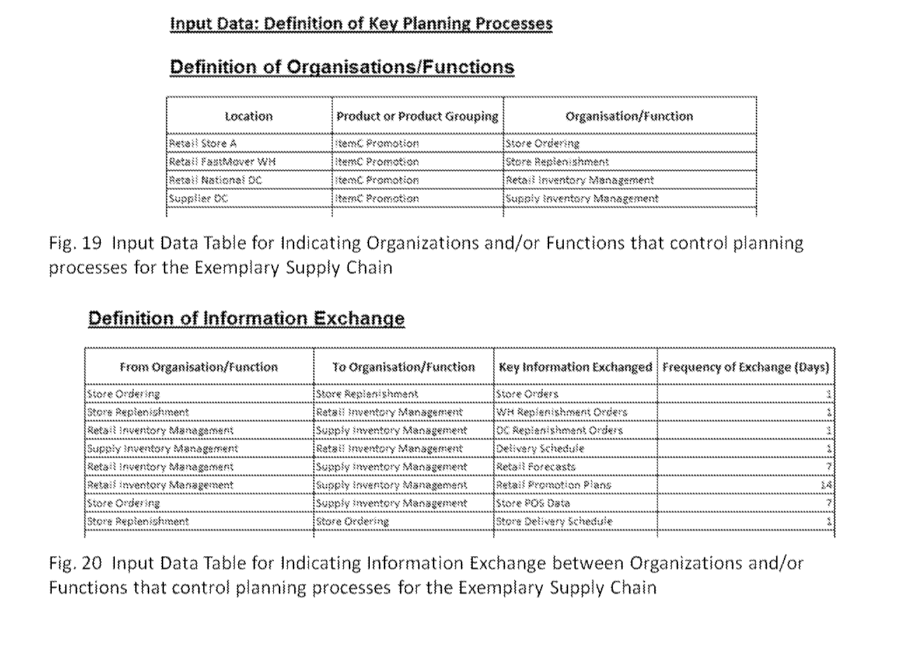

FIG. 19 is a table containing input data relating to organizations and/or functions that control planning processes for the exemplary supply chain;

FIG. 20 is a table containing input data relating to information exchange between organizations/functions that control planning processes for the exemplary supply chain;

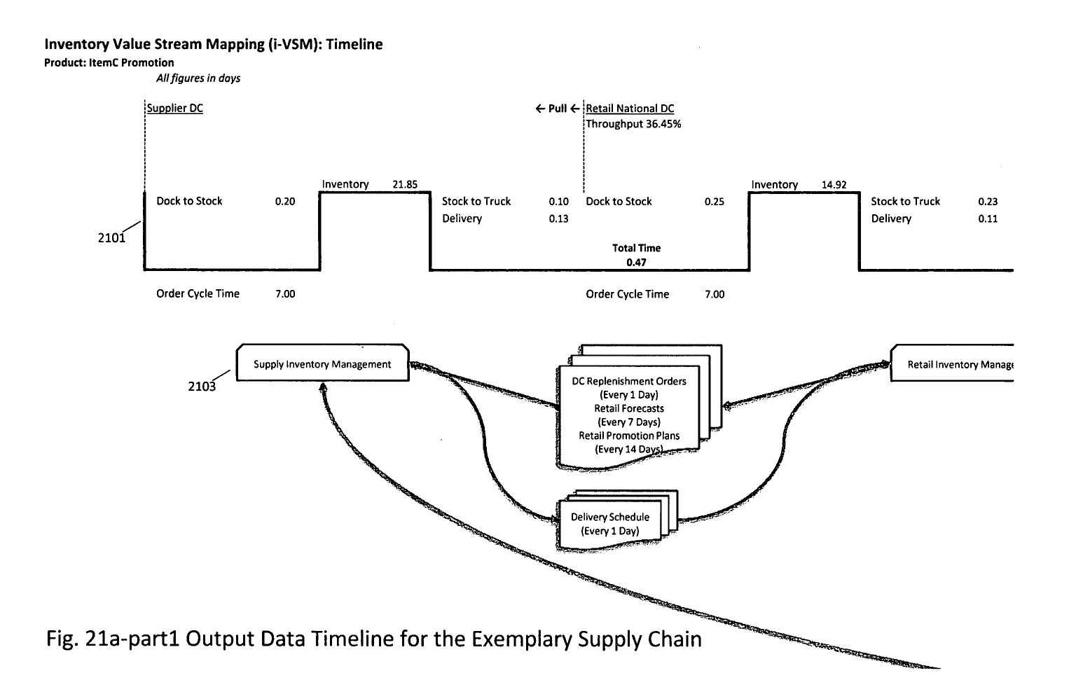

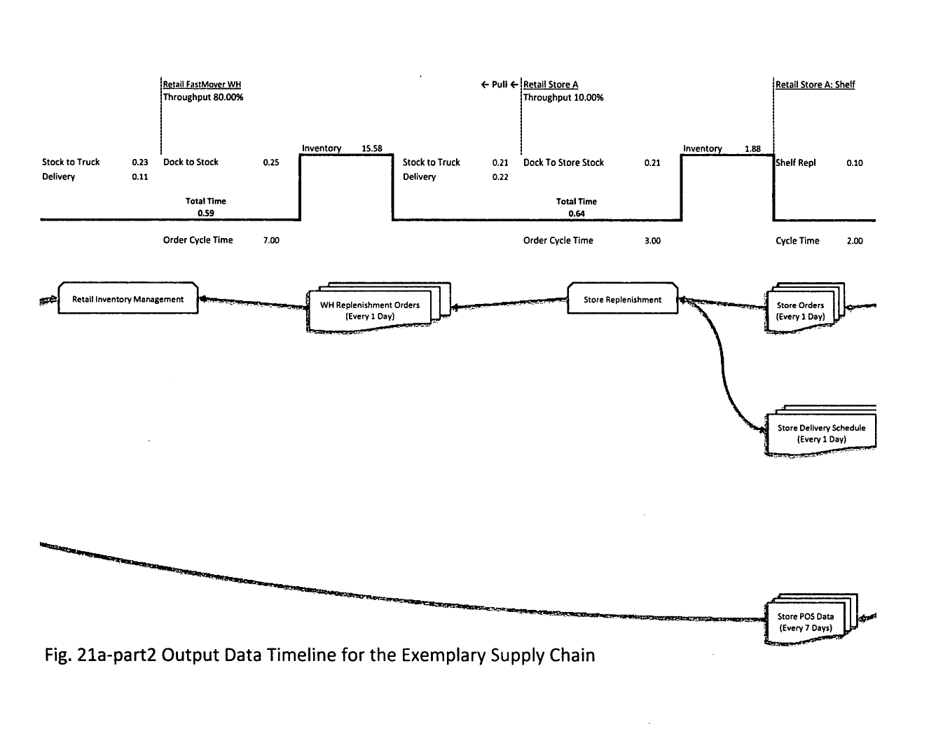

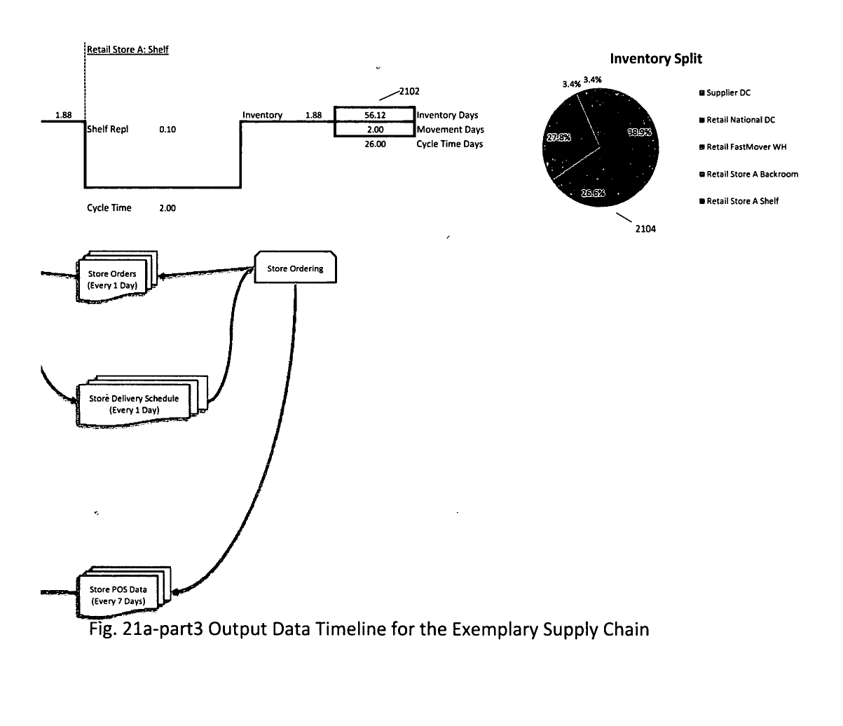

FIGS. 21a and 21b show an output timeline representation of a supply chain for a product in the exemplary supply chain;

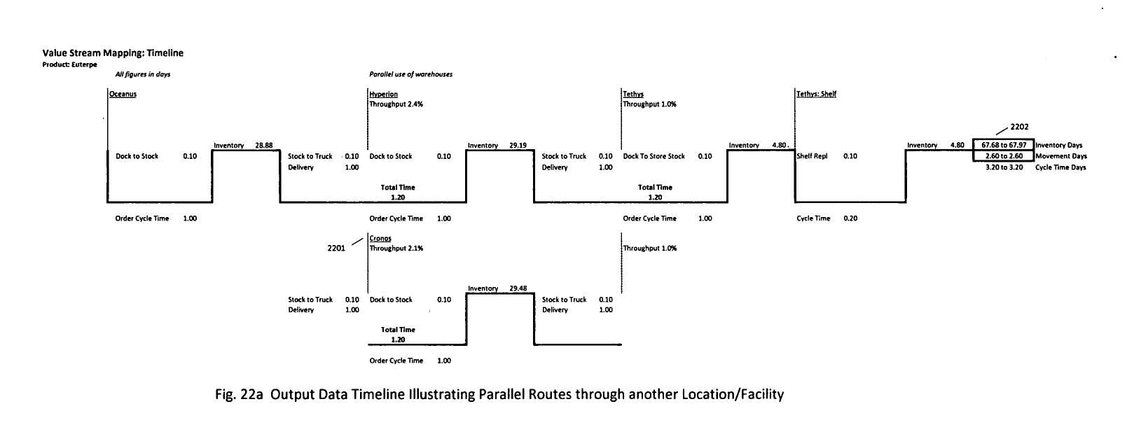

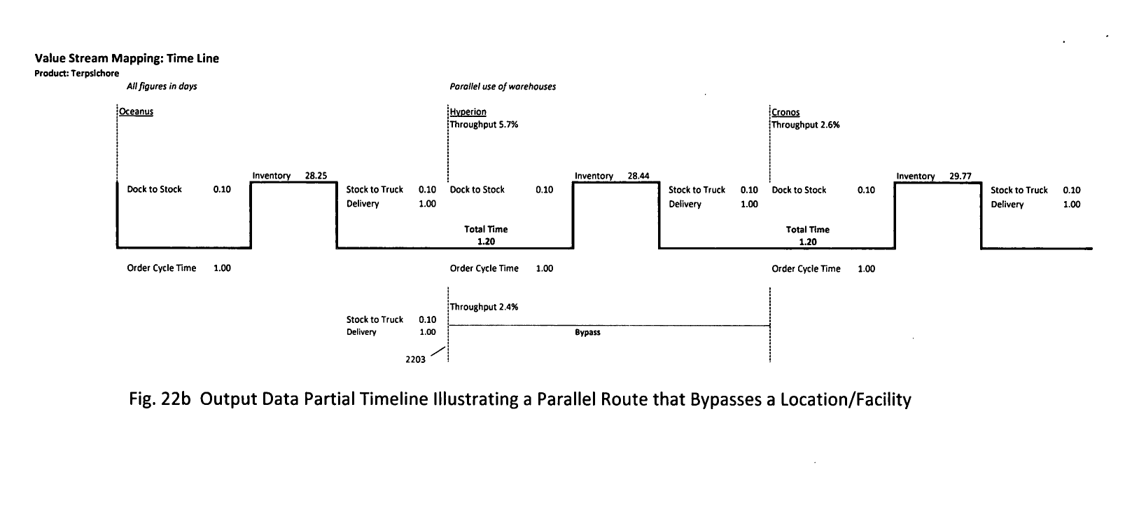

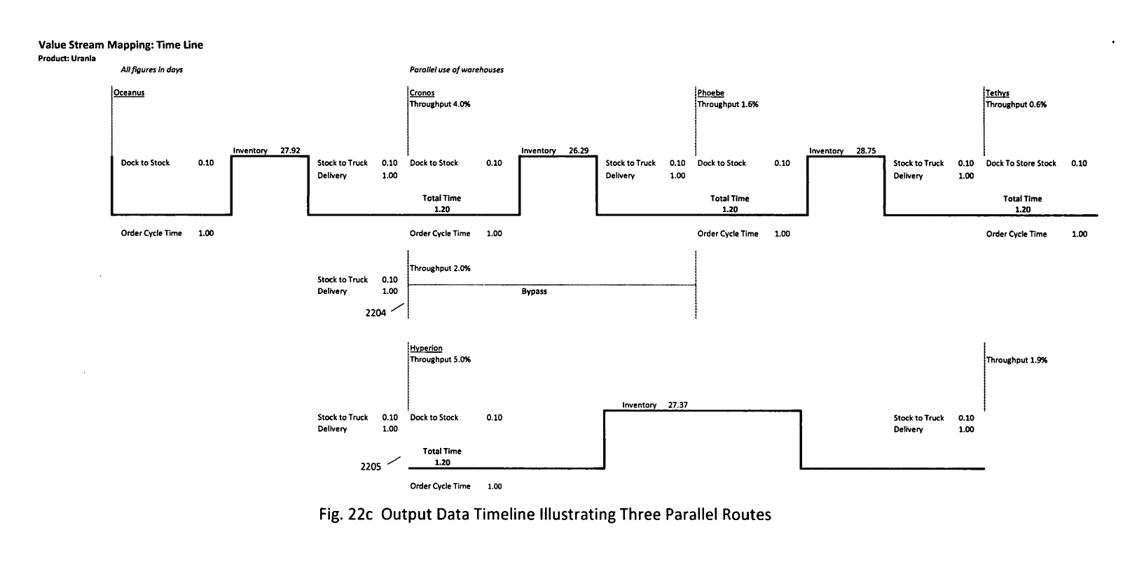

FIGS. 22a, 22b, and 22c show various output timelines for supply chains with alternative parallel routes;

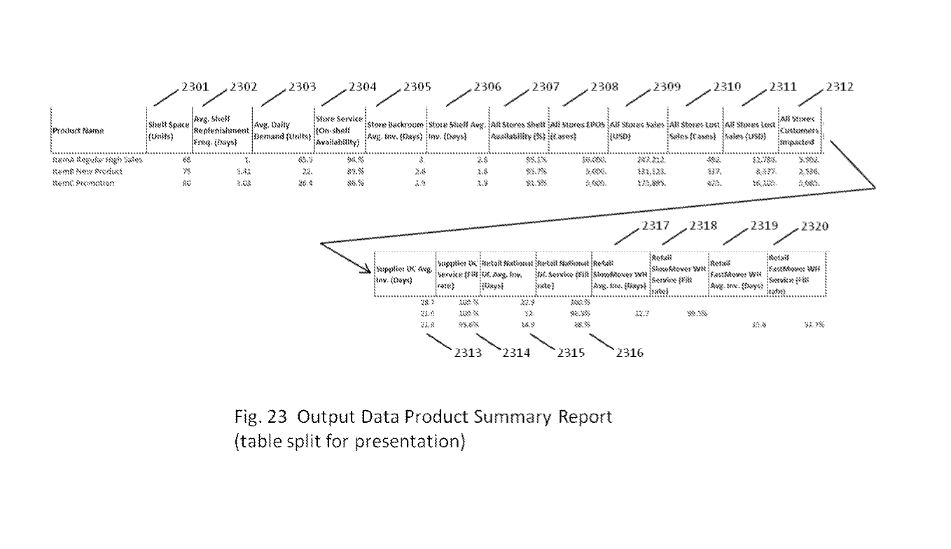

FIG. 23 shows output for a product summary report for the exemplary supply chain;

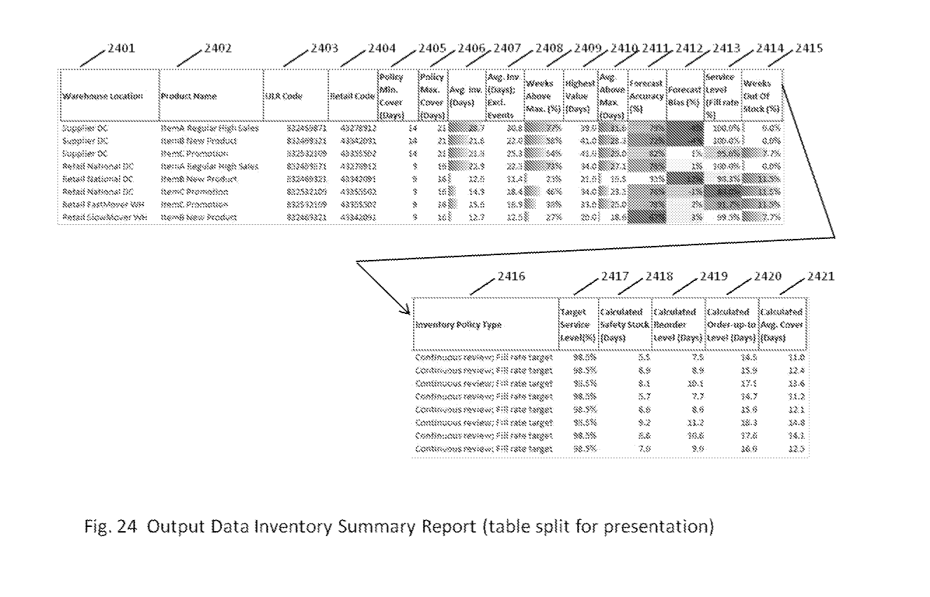

FIG. 24 is a table summarizing output data relating to inventory for each location and each product in the exemplary supply chain;

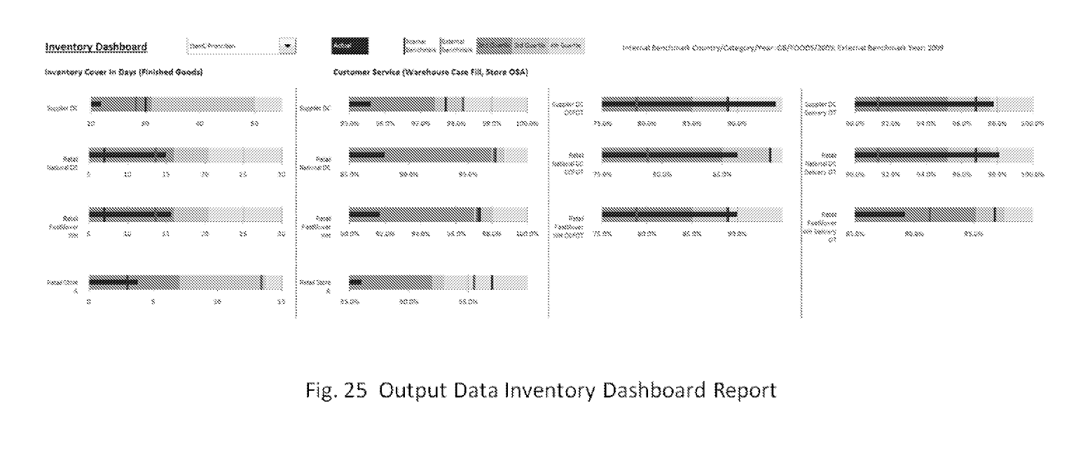

FIG. 25 is an output inventory dashboard report;

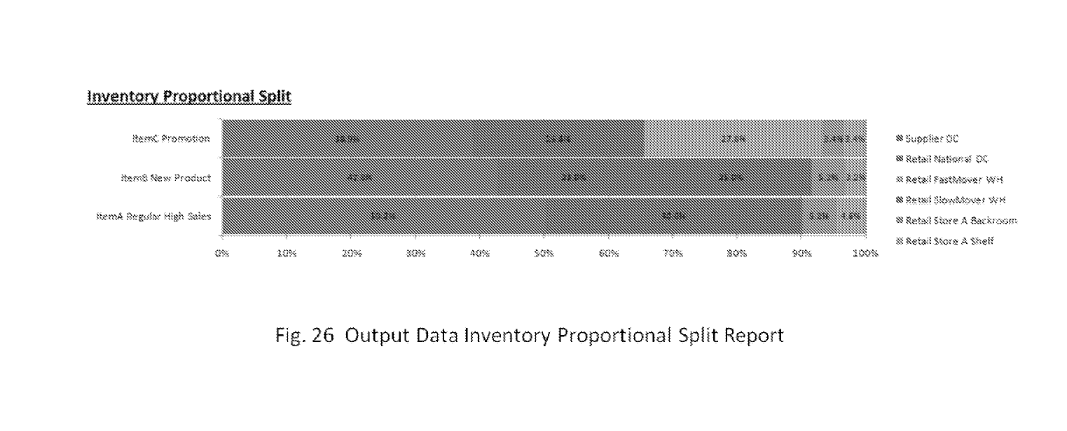

FIG. 26 is an output chart summarizing inventory proportional split by location for the exemplary supply chain;

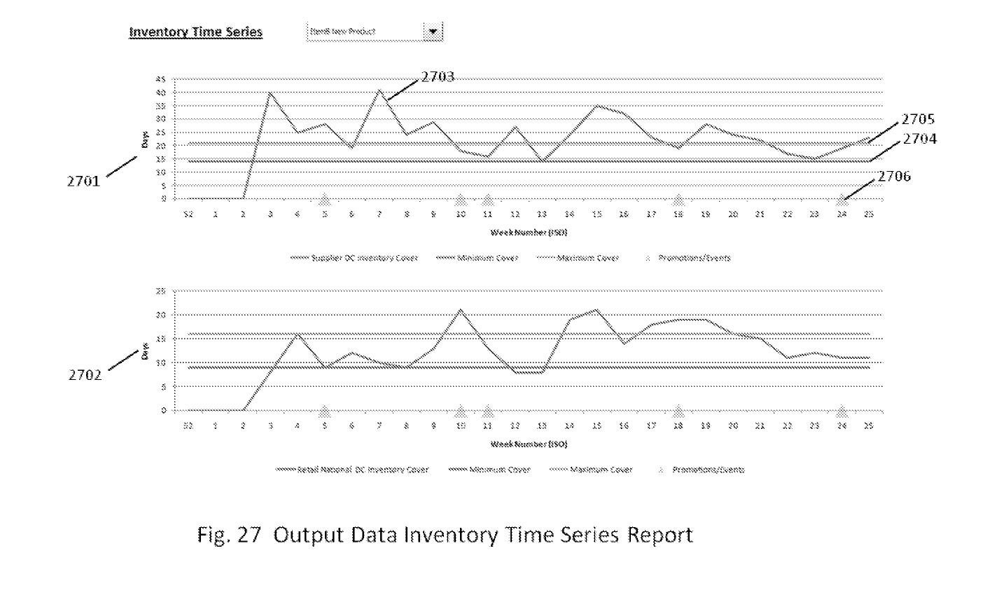

FIG. 27 illustrates output graphical representations of inventory time series over a defined period;

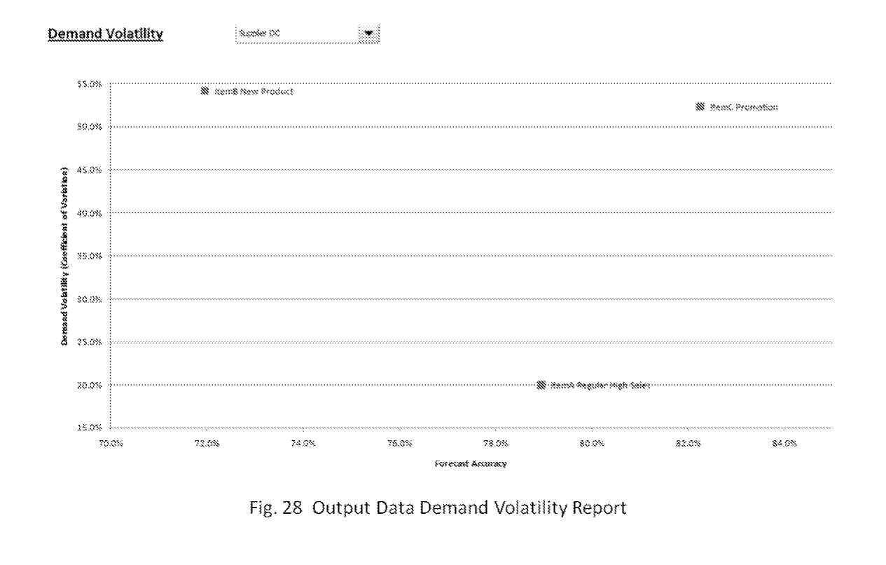

FIG. 28 is a plot of demand volatility versus forecast accuracy for products in the exemplary supply chain at a selected location;

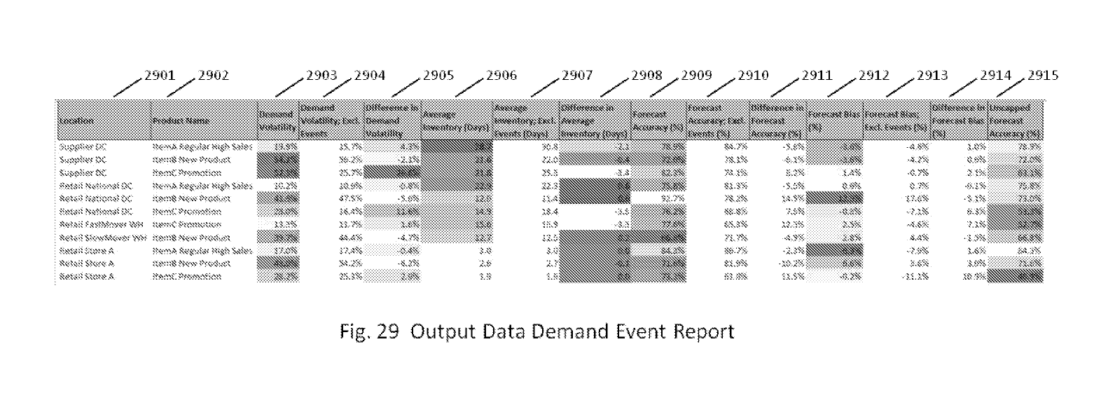

FIG. 29 is an output report showing the impact of demand events for the exemplary supply chain;

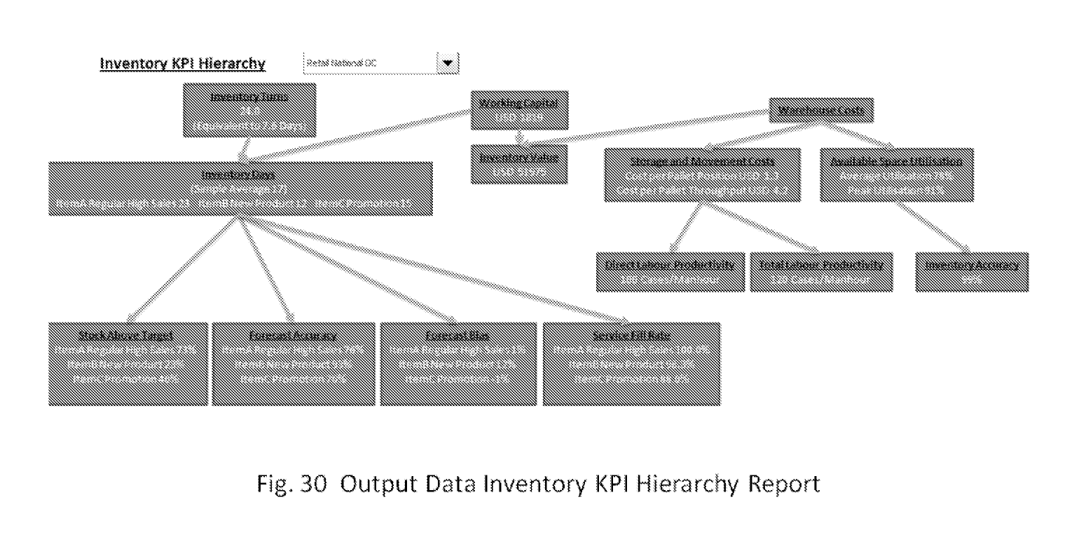

FIG. 30 is an output graphical representation of a hierarchy of inventory key performance indicators for the exemplary supply chain for a selected location;

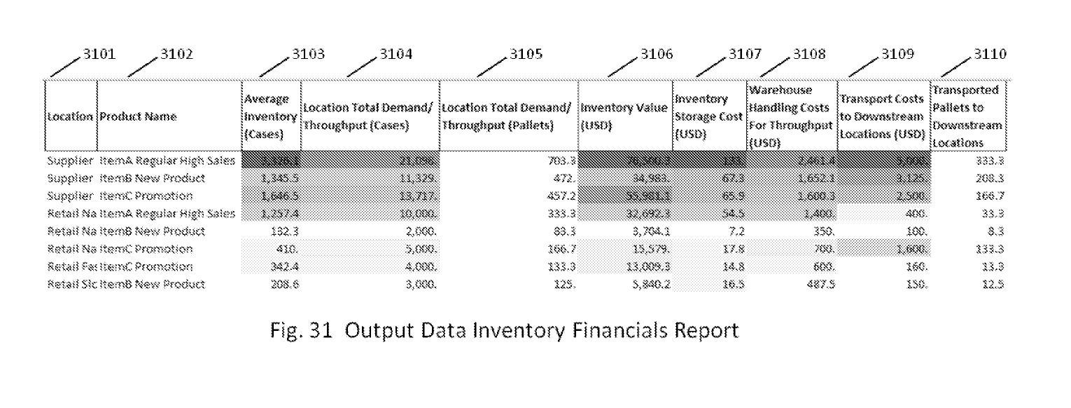

FIG. 31 shows an output report for inventory financial information for the exemplary supply chain at a selected location;

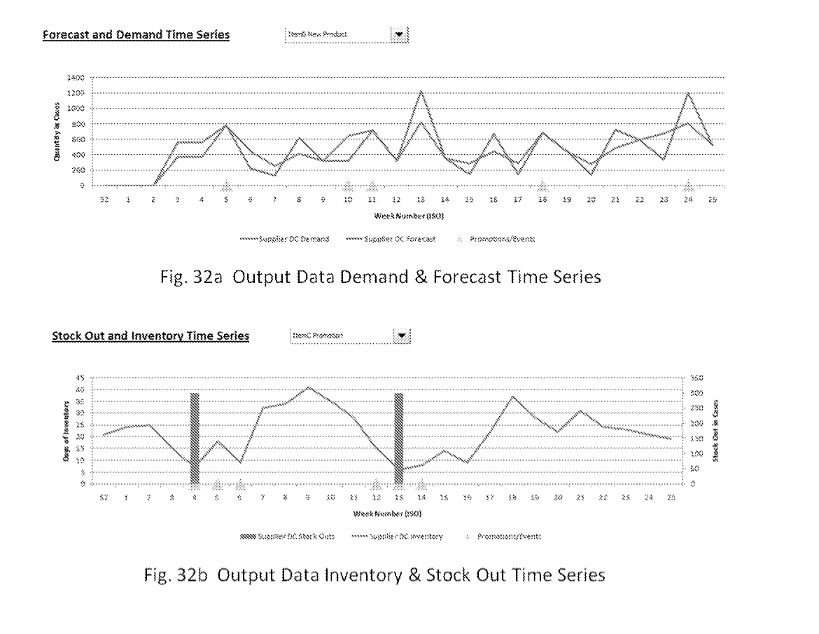

FIGS. 32a and 32b show other output plots of time series data over a defined period for the exemplary supply chain;

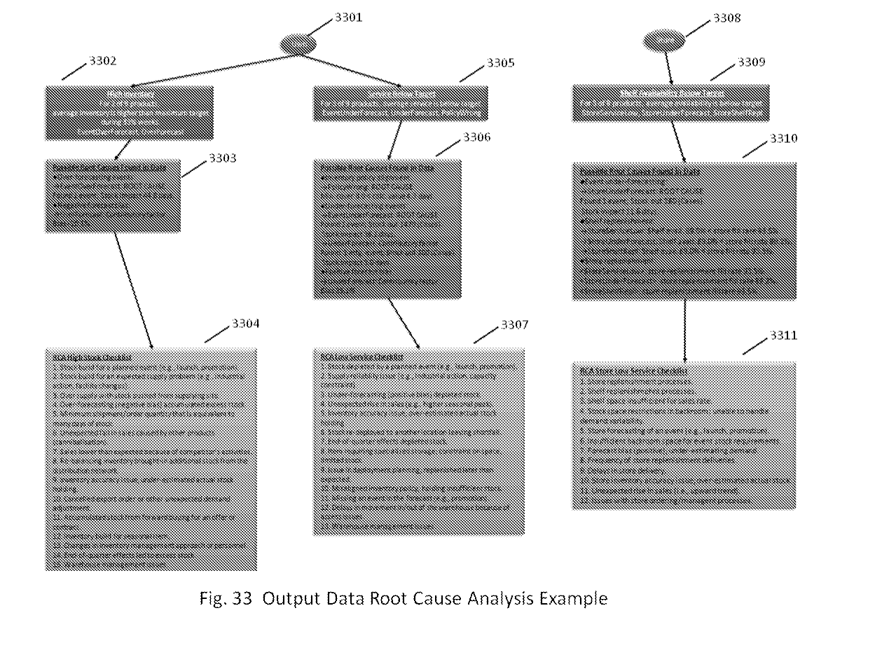

FIGS. 33 shows an example output for root cause analysis;

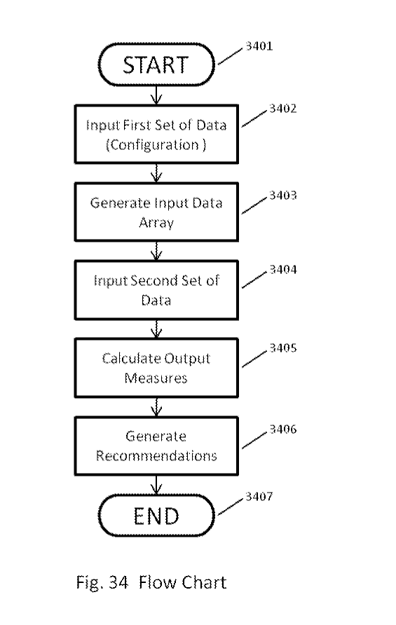

FIG. 34 shows a flowchart for an exemplary method according to the invention;

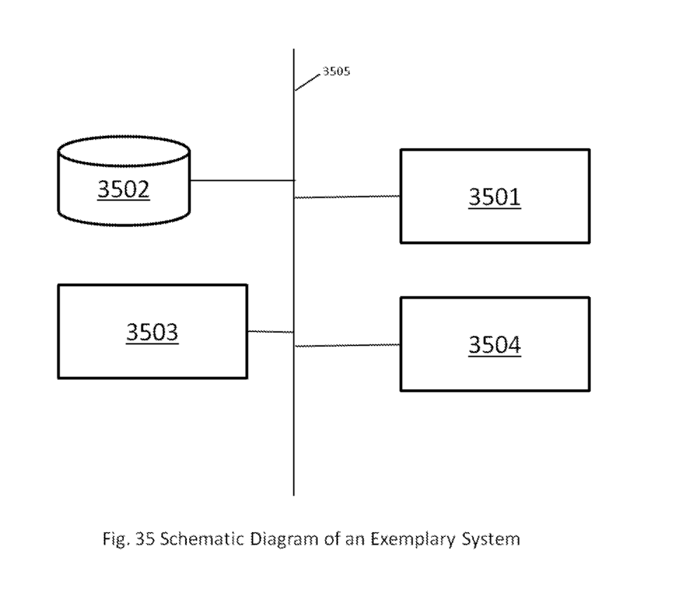

FIG. 35 is a schematic diagram of an exemplary system according to the invention; and

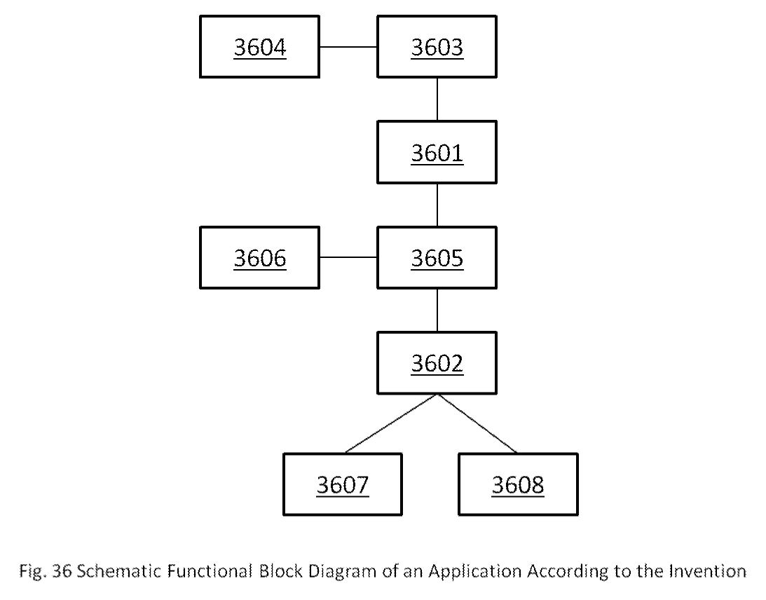

FIG. 36 is a schematic functional block diagram of an application according to the invention.

In accordance with an embodiment of the invention, FIG. 1 illustrates a series of method steps for analyzing a supply chain. The exemplary inventory value stream mapping process (termed ‘IVSM’) is initiated (step 1001) for a selected representative supply chain. At step 1002, a sample is taken of the product portfolio for the selected supply chain. The sample may be randomly selected, and this sample is preferably a stratified random sample in that a representative selection is made of different product types within the selected supply chain based on important shared attributes and characteristics. The sample may be based on specific market characteristics for a particular industrial sector. As an example, within a fast-moving consumer goods (FMCG) sector such characteristics might include: sales volume; rate of sales growth; distribution of sales volume; seasonal characteristics; promotional activities; market or sales channel characteristics; particular product variations; particular variations in supply chain operations affecting portions of a product portfolio; and specific types of problems or issues for supply chain operations such as inventory out of stocks and shelf availability.

At step 1003, data is entered to define the particular supply chain configuration that is being modeled. The configuration data is then verified (step 1004) and warnings or errors are provided to assist in correcting any problems within the data such as incomplete or inconsistent information. When the configuration is verified, input tables for data relating to the inventory value stream mapping are automatically generated (step 1005), and data is entered into these automatically generated tables (step 1006). Input data is then verified (step 1007) and warnings or errors are provided to assist in correcting problems within the data. When the input data is verified, calculations are then performed on the input data, resulting in automatic generation of a timeline (step 1008), including representations of information flows between the decision-making organizations or processes controlling the locations of the supply chain. Other steps 1009-1012 may also be incorporated into the process, which are not necessarily carried out sequentially but could follow directly from data verification (step 1007) or in addition to any other steps 1008-1012. For example, the process may include: automatic generation of interactive output reports with specialized formatting to highlight key insights about the input data (step 1009); automatic generation of a root-cause analysis tree and evaluation of path dependencies (step 1010); automatic construction of a discrete-event simulation model for dynamic inventory control (step 1011); and multi-criteria inventory optimization (step 1012). Below, further details about these steps are illustrated by way of example.

A value stream mapping process according to the invention may typically be focused on various areas of a supply chain. Examples include: a supply chain linking one or more material suppliers with a finished goods supplier and distribution network; a supply chain from a finished goods supplier distribution centre to a retail outlet (for example, a grocery store or supermarket shelf). These different examples of supply chains are illustrated schematically in FIG. 2. The supply chain network may involve many locations connected in a complex network of material flows, including return material flows.

In the supply chain illustrated in FIG. 2a, material suppliers 2001, 2002 supply materials to a finished goods supplier 2003. The finished goods supplier 2003 then supplies goods to one or more supplier finished goods distribution centers 2005 which in turn supplies one or more retailer distribution centers 2006. Additional supply routes may include other production locations 2004 including third-party producers, material suppliers 2001,2002 supplying materials to other production locations, the transfer of intermediate products between production sites (illustrated with two-way arrow between 2004 and 2003) and the transfer of goods from other production sites to the finished goods distribution centers 2005, 2006, including direct deliveries to the retailer.

For the purposes of the exemplary embodiments described herein, a supply chain linking a finished goods supplier with a retailer will be used, as shown in FIG. 2b. Similar principles can be applied to other types of supply chains such as the model in FIG. 2a.

In the exemplary supply chain illustrated in FIG. 2b, a finished goods supplier distribution center 2007 provides products to a retailer national distribution center 2010 and a retailer warehouse for slow-moving goods 2009, each of which supplies a retailer store 2011. The retailer national distribution center 2010 also supplies goods to a regional retail warehouse for fast-moving goods 2008. Each of the retailer warehouses supplies a store 2011 (which will typically be one of a number of stores), and the goods are sold in a retail environment on a store shelf 2012. The locations 2008, 2009, 2010, 2011, and 2012 are under the control of the retailer, whereas the location 2007 is under the control of the supplier.

Key questions to be addressed by inventory value stream mapping (IVSM) include: identifying where the inventory is located within the supply chain, the total amount of inventory held and the relative proportions being held by each participant and location; how to make the supply chain more responsive and reduce the time to shelf for any given product; how to improve and maintain shelf availability to end purchasers; how to assess whether inventory is performing its purpose in the supply chain; meeting target service levels; minimizing stocks to meet the required service levels; and how changing lead time requirements affect inventory and transportation costs and service. To answer these questions requires a level of overall visibility of what is occurring in a supply chain, taking into account all relevant processes that are occurring in the supply chain. To do this requires typically a large amount of data, which can make such analysis complex and difficult.

With currently available VSM techniques, visibility to the alternative physical, information and control routes through a supply chain can be absent or unclear for individual products. The current capabilities at times can be sophisticated and complex, but can fail to provide a user with an adequate comprehension of how inventory drivers interact and control the system.

In accordance with preferred embodiments of the invention, IVSM techniques are applied in the form of computerized spreadsheet-based tools developed to provide visibility to key information relating to the performance and interactions in the supply chain in question and to carry out certain diagnostics and root-cause analysis routines that generate insights into issues identified within the supply chain. The main focus of these tools is to provide quantified insights visually similar to management dashboards, enabling capture of an inventory time-line for specific products, key inventory and customer service metrics, and comparative benchmarking. Benchmarking can involve referencing external industry data (if available), internal benchmark data, and other calculated or estimated benchmarks from supplier and retail data.

The following exemplary embodiment is described to illustrate the principles according to aspects of the invention.

When starting the supply chain analysis according to embodiments of the invention, a first set of data is input that defines the supply chain and a selection of products that are distributed within the supply chain. This set of data is illustrated by way of example in the tables in FIGS. 3, 4 and 5. In addition to this set of data, information is also input concerning the time period being analyzed (e.g., in the form of a start date and number of weeks), concerning financial currency (e.g., currency symbol or corresponding letter code) and concerning other physical units of measurement for the process flows.

FIG. 3 shows a product portfolio definition table 3001, in which the selected products 3002 are defined and identified. Each product 3002 (in this example named ‘ItemA Regular High Sales’, ‘ItemB New Product’ and ‘ItemC Promotion’ and abbreviated to ‘ItemA’, ‘ItemB’, and ‘ItemC’, respectively) has a unique supplier item number 3003 and a retail item number 3004 so that each can be separately identified by the supplier and retailer. For example, the item number may be a Universal Product Code (UPC), European Article Number (EAN), Japanese Article Number (JAN) or Global Trade Item Number (GTIN). Each product is assigned a category 3008, which may for example be dependent on particular characteristics of the product, and which can be used to determine how the product is to be handled and which route the product will need to pass through the supply chain. The product category may be used during comparative benchmarking of the supply chain performance, indicating which internal or external benchmarking data set should be used when benchmarking data is typically provided for different product categories. Other details including the number of trade units per case 3011 and the number of cases per pallet 3012 are input for each product. Other information may optionally be included, such as a brand name 3005, a description of the product 3006, a size of the product 3007, a sub-category 3009, retail category 3010 and product grouping 3013. This other information is not however necessary for the purposes of performing the supply chain analysis. Product grouping is used to define groups of products in situations where the groups are useful for more efficient entry of data in other input tables; for example, the supply chain control and planning processes defined in the input tables shown in FIG. 19 and FIG. 20.

FIG. 4 shows a location definition table 4001, in which the locations 4002 in the supply chain are defined and identified. Each location is assigned a type 4003, in this example one of a supplier warehouse, a retail warehouse and a retail store. An indication 4004 is provided of whether time series data is available, and a country code 4005 is selected for each location. The country code may be used during comparative benchmarking of the supply chain performance, indicating which internal or external benchmarking data set should be used when benchmarking data is typically provided for different countries. Other information that is not required for performing the supply chain analysis such as a region 4006 and city 4007 may also be included for the locations.

FIG. 5a shows a supply routes definition table 5001, which provides information relating to supply routes that connect the locations 4002 defined in the location definition table 4001. One or more supply routes are defined for each of the products being distributed in the supply chain in the form of a location 5002 and a ‘supplies-to location’ 5004 for each product name 5003. The quantity 5005 supplied to each ‘supplies-to location’ 5004 is provided, in terms of the total number of cases supplied over a given time period being analyzed. As shown in FIG. 5b, the supply routes definition table can also be configured if necessary to provide units of measure 5006 for the quantities supplied between locations.

The information provided in the tables illustrated in FIGS. 3, 4 and 5 define the structural configuration of the supply chain to be analyzed, in the form of the way in which each product is distributed from location to location. A diagram representing the exemplary supply chain thereby defined in FIGS. 3, 4 and 5a is shown in FIG. 6. The supplier distribution center (Supplier DC) 6001 supplies ‘ItemA’, ‘ItemB’ and ‘ItemC’ to the retail national distribution center (‘Retail National DC’) 6002, which in turn supplies ‘ItemA’ and ‘ItemB’ to a retail store (‘Retail Store A’) 6005. The supplier distribution center 6001 also supplies ‘ItemB’ to a retail warehouse (‘Retail SlowMover WH’) 6003, which in turn supplies the product to the retail store 6005. The retail national distribution center 6002 also supplies ‘ItemC’ to a retail warehouse (‘Retail FastMover WH’) 6004, which in turn supplies the product to the retail store 6005. This type of diagram may be automatically generated as part of the process of supply chain analysis.

Once the first set of data defined in the tables in FIGS. 3 to 5 is provided, an input data array having dimensions corresponding to the plurality of products, locations and supply routes input is generated. A second set of data relating to measured and forecast flows of the products through the supply chain over a defined period is then input into this generated input data array. The tables illustrated in FIG. 7 to FIG. 20 indicate the types of data that are input into this input data array, with the dimensions of the tables generated according to the form of the first set of input data. Some of this data is required for carrying out analysis of the supply chain, whereas other data is merely optional.

FIGS. 7 to 20 show tables containing input data relating to operation of the exemplary supply chain, each of which is described briefly below. The data input to the tables in FIGS. 16 to 20 may be considered optional for the purposes of supply chain analysis, whereas the data input to the tables in FIGS. 7 to 11 are required for supply chain analysis.

FIG. 7 shows four tables indicating the movement timing and transportation delivery times relevant to the exemplary supply chain, which are required for calculating the time taken for any given product to progress through the supply chain. Multiple tables for movement timing are created automatically to reflect desired relationships among the input data. For the exemplary supply chain: warehouse inbound and outbound handling 7001 may vary by warehouse location; and store order cycle time 7002 may vary by product. Input data such as ‘dock to stock’ (average time required to move products from a warehouse receiving dock into warehouse stock locations) and ‘stock to truck’ (average time required to move products from warehouse stock locations until a truck is loaded) timings are provided for each warehouse type location defined in the location definition table 4001. The store movement and handling 7003 includes ‘dock to stock’ for the store location (defined in location table 4001) and includes average shelf replenishment (‘Shelf Repl.’) timing and cycle time. The delivery times 7004 between locations (which were defined as having supply routes 5001) are input alongside an average transport cost for moving each pallet and an average percentage truck utilization for the given delivery route.

FIG. 8a shows a table for the exemplary supply chain for entering input data relating to inventory held at each stock location for each product. The inventory is entered in the form of the number of days of forward demand coverage held at each stock location at the beginning of each week of the defined time period. FIG. 8b shows the input data for inventory at the store location is configured to automatically allow for two stock locations at the store backroom 8001 and the store shelf 8002. FIG. 9 shows a table for entering inventory stock outs, in this case in number of cases, for each product at each location and for each week over the defined time period. Inventory stock outs provide information on any inventory shortfalls versus the quantities ordered from each location. For stores, stock outs are typically estimated figures based on expected sales patterns.

FIG. 10 shows a table of input demand data, with each number in the table indicating the demand, in this example in number of cases, for each product and at each location, which is required for analyzing the supply chain. The dimensions of the table are generated according to the configuration defined by the first set of data entered. In the case of the Supplier DC and Retail Store locations, information is required for each of the three identified products, since these locations handle all three products, as defined in the first set of data. For the Retailer DC1, DC2 and DC3 locations, however, only two of the products are handled in each case. The Retailer DC1 location handles the products identified as New Product and Regular, whereas the Retailer DC2 and DC3 locations handle the products identified as Twin Pack and Regular, as indicated in the supply routes definition table in FIG. 5. Data relating to demand from each of these locations is entered over a defined time period, which in the illustrated case is over a period of weeks, with data entries for each week in the defined period.

FIG. 11 shows a table for entering input data relating to weekly forecast data, in this example in number of cases, for each product at each location.

FIG. 12 shows a table for entering indications of when events have occurred during the modeled time period for the exemplary supply chain; in this example, a weekly event calendar is shown. An event, which is identified for each product, is an activity that is expected to influence demand for a product. It may for example be a promotional event such as a temporary price reduction (e.g., two for one promotional offer). Such an event will for example impact forecast accuracy and deplete inventory levels if the forecast has not anticipated all of the extra promotional demand, and can therefore usefully be taken into account in subsequent calculations and assessments. Multiple event calendars can be configured for different locations in the supply chain if needed.

FIG. 13 shows two tables for entering input data relating to key performance indicators (KPIs) for inventory management of the supply chain. The first table 1301 is provided for entering summary inventory performance measurements for each warehouse location and such measurements include inventory turns and the financial working capital charge for each location. The second table is provided for entering various data related to inventory control for each product handled by each warehouse location. The inventory control data include the inventory policy: minimum cover or re-order point; maximum cover or order-up-to point; inventory valuation; order cycle time; type of inventory review; type of target service level; target service value; replenishment lead time; variance in replenishment lead time; review period; and minimum order/shipment quantity. Each of these tables (1301, 1302) is generated automatically according to the first set of configuration data relating to locations (FIG. 4) and supply routes (FIG. 5).

FIG. 14 shows tables for entering input data for customer service KPIs. The first table 1401 is for entering data for each product at the retail store and this data includes shelf availability, shelf space available and the target shelf availability. The second table 1402 is for entering data for each product at each warehouse and this data includes case fill rate and warehouse CCFOT (customer case fill on time). The third table 1403 is for entering summary data for transportation service performance from each warehouse and this data includes transportation CCFOT for all outbound shipments from each location.

FIG. 15 shows a table for entering input data for cost KPIs for each warehouse location. The cost KPI data includes: cost per pallet (storage) position; cost per pallet throughput; average (storage) space utilization; peak (storage) space utilization; direct labor productivity; total labor productivity; inventory accuracy; warehouse damages and shrinkage; and transport damage and shrinkage.

FIG. 16 shows a table for entering input data for environmental and safety KPIs for each warehouse location. This data includes: transport carbon dioxide (or greenhouse gas) emissions; warehouse carbon dioxide (or greenhouse gas) emissions; and loss time accidents.

FIG. 17 shows a table for entering retail contextual data for each product for all retail stores over the modeled period, which includes shelf availability 1701, (EPOS, electronic point of sale) total quantity sold (in this example as number of cases) 1702, and sales value 1703 (in modeled currency units), lost sales quantity (in this example as number of cases) 1704 and monetary value 1705 and estimated customers impacted from lost sales 1706. This data provides the supply chain context for the retailer's performance versus the performance of individual stores being analyzed.

FIG. 18 shows a table for entering input data which indicates the way in which product shipments are controlled through the supply chain in terms of whether the shipments are ‘pushed’ from a supplying location to a ‘supplies-to’ location or ‘pulled’ by a ‘supplies-to’ location from a supplying location. When shipments are pushed, decisions about the quantity and the timing of the shipments are influenced more by the supplying location. When shipments are pulled, those decisions are influenced more by the location being supplied. FIG. 18 shows data for the exemplary supply chain. The first row of data 1801 shows an example of the use of Product Grouping to simplify data entry. In the example, Product Grouping ‘ALL’ is defined to be a group containing all the products in the product portfolio (FIG. 3, 3013).

FIGS. 19 and 20 show two interlinked tables for entering input data which indicates the organizations and/or functions that plan, manage and control the supply chain at the various modeled locations, the information exchanged and the frequency of exchange. FIG. 19 shows the table for defining each modeled organization/function in relation to the location and product or product grouping that is planned or managed. FIG. 20 shows the table for defining the information exchanged between the organizations/functions and the frequency of the exchange; the allowable entries for organizations/functions in this table are automatically excluded to those already defined in the table shown in FIG. 19.

Once all the required input data is provided, the data is verified for consistency and any errors are highlighted for correction before various calculations and comparisons are performed on the data and various output visualizations and recommendations are generated as a result. Examples of the types of outputs are illustrated in FIGS. 21 to 33 and described in detail below.

FIG. 21a illustrates an exemplary inventory value stream mapping timeline 2101 generated from the input data, in which the example output is shown for product ‘ItemC’ based on the input data relating to movement and timing (FIG. 7), and inventory KPIs (FIG. 13). Inventory value stream timelines are product specific and one is produced for each modeled product. Conventional value stream maps represents a timeline visually like a single rectangular wave moving through a series of manufacturing process steps with two sets of values shown on the timeline: value-added and non-value added time for each step. Non-value added time is typically shown on the crests of a timeline while value-added time is typically shown within the troughs.

FIG. 21b shows a more detailed view of part of the timeline from FIG. 21a. In an inventory value stream mapping timeline, there are three sets of values representing: 1) value-added movement and processing activities (shown in the troughs) 2105; 2) inventory represented as a time value 2106 (shown on crests where non-value adding time is usually shown); and 3) order cycle times 2107 (shown below the timeline) for processes flowing inventory through a supply chain. For shipments between supply chain locations, time components are typically shown separately for outbound and inbound activities 2108, along with a total time for moving inventory between the locations 2109.

At the end of the timeline, in FIG. 21a, the total amount of time is shown for the 3 sets of values 2102; and if there are alternative flow routes in the supply chain, then a value range is shown based on the minimum and maximum times for the alternative routes (see FIG. 22a for an example 2202). To the right of the timeline, in FIG. 21a, a pie-chart 2104 shows the proportions of the total inventory at each of the locations in the supply chain.

Within the timeline shown in FIG. 21 for the exemplary supply chain, movement of inventory is shown with components labeled ‘Dock to Stock’, ‘Stock to Truck’, ‘Delivery’, and so on. These components represent the time required to move inventory from warehouse loading and unloading docks, to and from storage locations within warehouses, and include time for loading and unloading vehicles, and time for transportation between supply chain locations. Time components and labels can be altered, depending on the requirements of the model.

Above the timeline (see FIG. 21b) are labels indicating each supply chain location 2110 a particular product flows through, indictors for whether supply is controlled via push or pull 2111, and the proportion of total throughput 2112 for the product that flows between upstream and downstream locations. The timeline shows where the physical inventory is located and how long it takes for a product to flow end-to-end through a supply chain, including the delays caused by the time it takes to pass through the various inventories along the route (assuming a sequential last in last out approach). Cycle times are incorporated already within inventory values when inventory is represented as a time value (such as days of supply or forward cover), which is why cycle times 2107 are shown as separate components in the timeline to prevent double counting.

FIG. 21 also illustrates an example of how the various organizational functions and processes for planning and managing a supply chain are output below the timeline 2103, including key information exchanged and how frequently. In the example shown for product ‘ItemC’, output is based on the inputs that were shown in FIGS. 19 and 20.

The output timeline is enhanced with notation for representing parallel or alternative supply chain routes, which is needed for applying inventory value stream mapping to supply chains. FIG. 22 illustrates the notation used for parallel or alternative routes. FIG. 22a shows a timeline that contains a parallel route 2201 through an alternative location or facility; in this example, Oceanus can ship inventory to Cronos 2201 as well as Hyperion, which is an alternative route for inventory flowing to Tethys. FIG. 22b shows a timeline with a route that bypasses a location 2203; in this example, inventory shipments from Oceanus can bypass Hyperion and be sent directly to Cronos 2203. FIG. 22c shows a timeline with three parallel routes, including a route that bypasses a location 2204, and a route where an alternative location replaces multiple locations 2205; inventory shipments from Oceanus can bypass Cronos and be sent directly to Phoebe 2204, and inventory shipments can be sent to Hyperion 2205, instead of flowing through two locations Cronos and Phoebe, to reach Tethys.

FIG. 23 illustrates an exemplary product report generated for each of the products in the supply chain. This product report summarizes calculated daily demand by product and the average inventory in days at each location together with the respective service level measures. This gives an overall picture of the correlation between how much inventory is held at each location by product and the actual customer service levels. The output information in the product report is derived from the input data in the Customer Service KPI table (FIG. 14), the product portfolio definition table (FIG. 3), the input demand data (FIG. 10), the input inventory data (FIG. 8) and the input retail data for the retailer stores (FIG. 17). The shelf space 2301, store service 2304 and fill rates 2314, 2316, 2318 are taken directly from the figures provided in the Customer Service KPI tables (FIG. 14). The average daily demand 2303 is calculated from the average weekly input demand for each product (FIG. 10) and the number of units per case (FIG. 3). The average shelf replenishment frequency 2302 is calculated by dividing the shelf space by the average daily demand. The store backroom average inventory 2305, store shelf average inventory 2306, Supplier DC average inventory 2313, Retail National DC average inventory 2315, Retail SlowMover WH average inventory and Retail FastMover WH average inventory 2417 are taken directly from the input inventory data (FIG. 18). The ‘All Stores Shelf Availability’ 2307, ‘All Stores EPOS’ 2308, ‘All Stores Sales’ 2309, ‘All Stores Lost Sales’ 2310, 2311 and ‘All Stores Customers Impacted’ 2312 measures are taken directly from the input retail data for the retailer stores (FIG. 17).

FIG. 24 shows an inventory summary report, which is generated from analysis of the input data. This table summarizes inventory data by location 2401 and product 2402. A user is able to visualize from this table alone whether there is any correlation between average inventory days 2407, 2408, forecast accuracy and bias 2412, 2413 and service level 2414, as well as understand the impact of any events on these measures because the output provides measures of average inventory levels with events included 2407 and with events excluded 2408 (ignoring weeks where an event is indicated, FIG. 12). The model performs various calculations relating to inventory policies 2418, 2419, 2420, 2421, which can be compared against the stated inventory policy minimum and maximum cover 2405, 2406.

Depending on the inventory policy parameters chosen, the model performs different calculations. For example, there are four different combinations for the inventory policy calculations when the review period may be either continuous or periodic and the target service level may be either based on fill rate or availability. The inventory policy type 2416 and target service level is derived from the input data in the Inventory KPIs (FIG. 13).

The inventory policy calculations are based on known statistical formulae for calculating safety stock. The following is an example of the inventory calculations that are used in the model:

If P is defined as a period of uncertainty, which safety stock is protecting against, for a continuous review period, P=Order Cycle Time, and for a periodic review period, P=Review Period+Replenishment Lead Time.

MeanDemand is defined as an average demand over the period of uncertainty P, which therefore depends on the review period. If P is measured in Days,

MeanDemand=P*Average Weekly Demand/7

Sigma is defined as the standard deviation of forecast errors, and SigmaP is the standard deviation of demand during P, calculated as:

SigmaP=SQRT(P*Sigmâ2+MeanDemand̂2*Variance Lead Time)

where SQRT means a square root and ̂2 means squared and SigmaP assumes weekly forecast errors (if these are not available, a correction factor is needed).

The standard calculations for a service level fill rate target (FillRate) are as follows:

C=0.92+Ln(MeanDemand*(1-FillRate)/SigmaP)

K=(−1.19+SQRT(1.4161−1.48*C))/0.74

SafetyStock=K*SigmaP

ReorderLevel=SafetyStock+Replenishment Lead Time*Average Weekly Demand/7

OrderUpTo=ReorderLevel+MeanDemand

where Ln is the natural logarithm, SafetyStock is the safety stock quantity, ReorderLevel is the quantity that triggers reordering of inventory replenishment, and OrderUpTo determines the maximum quantity that could be ordered.

The standard calculations for a service level availability target (Availability) are as follows:

OrderUpTo=Norminv(Availability, MeanDemand, SigmaP)

SafetyStock=OrderUpTo−MeanDemand

ReorderLevel=SafetyStock

where NormInv is a statistical function that returns a value V from a normal cumulative density function such that for a given probability, mean and standard deviation a normal random variable takes on a value less than or equal to V.

For both calculations, the average cover (AvgCover) is calculated as:

AvgCover=MinCover+0.5*(MaxCover−MinCover)

The above calculations give stock quantities, which are converted into days based on the average daily demand.

It is important that the calculations are carried out using consistent units. In the examples provided weekly data is used and all inputs are consistent with a period of one week.

The tables below provide an example calculation.

| | Example |
|---|---|
| | Calculation |
| Order Cycle Time (P) in Days | 7 |
| Mean demand per week | 18100 |
| Average daily demand | 2586 |
| Sigma | 1,747 |
| Variance lead time | 0.3 |
| SigmaP | 10067 |
| Fill rate target | 98.5% |
| C | −2.69 |
| K | 1.53 |
| Replenishment lead time | 3.00 |
| Safety Stock | 15429 |
| ReorderLevel | 23186 |
| OrderUpTo | 41286 |

| | Calculated |
|---|---|
| | Days |
| Calculated Safety Stock (Days) | 5.97 |
| Calculated Reorder Level (Days) | 8.97 |
| Calculated Order-up-to Level | 15.97 |
| (Days) | |
| Calculated Avg. Cover (Days) | 12.47 |

In the inventory summary report, special formatting may be used for certain important output measures to indicate whether these measures are within or outside preferred or expected bounds. In the example shown in FIG. 24, shading bars have been applied to

Average Inventory 2408, Weeks Above Maximum 2409, Average Above Maximum 2411 and Weeks Out Of Stock 2415. Shaded cells have been applied to Forecast Accuracy 2412, Forecast Bias 2413, and Service Level 2414. Shaded bars show the relative magnitude of the values, similar to a bar chart. Shaded cells show the relative dispersion of the values, increasing color intensity indicating the values lying at the upper or lower ranges in the data.

For example, the average inventory level 2407 can be compared with the stated policy levels 2405, 2406 and colored shading used to indicate whether the level is within or outside these policy levels. In FIG. 24, the inventory summary report, the average inventory level for the ‘ItemA’ product at the Supplier DC location is above the policy maximum cover, and this high average inventory is easily picked out by the shading to bring this to the attention of the user. Other measures such as the percentage of weeks above the maximum policy level 2409 may also be shaded accordingly. In the example shown, the ‘ItemA’ product can be seen to have inventory levels above the policy maximum for 77% and 73% of the time at the Supplier DC and Retail National DC locations, respectively. This indicates to the user that these higher than expected inventory levels at these locations need further investigation, for example by determining whether the policy level is appropriate or by analyzing why inventory levels are consistently high at these locations. Such shaded areas in the report can therefore be considered to be recommendations to the user for further investigation.

A useful measure is obtained by comparing the average inventory level with and without events 2407, 2408. This can be used to demonstrate whether events are adversely impacting average inventory levels and whether the policy levels are appropriate. The possible causes of unexpected inventory levels can thereby start to be narrowed down.

Comparing the calculated inventory policy levels 2418-2421 with the stated current policy levels 2405, 2406 allows the user to determine whether any further investigation is required, for example if the calculated levels are significantly different from the current policy.

Various measures obtained from the input data may also be illustrated and compared in other visual ways, for example in a “dashboard” of bullet graphs such as the one shown in FIG. 25. In this dashboard, the bullet graphs show measures of inventory days cover and customer service for each of the locations for a selected product. The actual measures are compared against internal and external benchmark data to help assess the relative quality of the performance metric; in this example, benchmark data is provided by country, product category and year. Statistical analysis of the benchmark data also provides quartiles for judging relative performance in a wider context. In FIG. 25, the customer service measures include warehouse case fill rate and store on shelf availability (OSA), warehouse customer case fill on time (CCFOT), and transportation delivery on time (OT). Multiple service measures help to highlight where particular customer service issues might be occurring.

FIG. 26 illustrates a chart indicating the proportion of inventory that is allocated between each location for each product, which provides a visual representation of the typical distribution of product inventory throughout the supply chain. In the example for the ‘ItemC’ product, 38.9% of the total inventory days are located at the Supplier DC location, whereas for the ‘ItemA’ product the figure is 50.2%. This information is derived from the input inventory data for each product at each location in the supply chain.

FIG. 27 shows an example of inventory time series plots for a selected product at various supply chain locations; the plots are presented for each sequential location that the product flows through in the supply chain. In this example, only two locations are shown for easier presentation for ‘ItemB’, the Supplier DC 2701 and Retail National DC 2702. The plots show the historical weekly inventory cover 2703 in relation to the minimum cover 2704 and maximum cover 2705, and indications 2706 are provided for each week where an event has been indicated as occurring. This shows visually the inventory behavior throughout the time horizon at each of the physical locations. For example such a chart could be used to visualize how well inventory is being managed, where out of stock issues occur or high inventory occurs in relation to events, and trace how inventory issues at upstream and downstream locations interact, and whether inventory profiles at different supply chain locations show similar behavior. In a general aspect therefore, the method according to an aspect of the invention may comprise presenting a graphical representation of interconnected inventory levels for one or more of the plurality of locations in the supply chain over a defined sampling period. The graphical representation may indicate predefined maximum and/or minimum inventory levels over the defined period and events that could impact the management of inventory levels.

The time series plots represented in FIG. 27 should be used taking into account time lags for movement and management planning cycles through the supply chain, which can be indicated alongside the charts for easier interpretation. For example, the impact of a low inventory in week 1 at the Supplier DC may not impact on supply to downstream locations until following weeks, allowing for transportation and planning activities. This type of chart is therefore generally useful for visibility of potential issues and for gaining some insights about potential root causes where these arise from interconnected inventory issues.

FIG. 28 illustrates an example plot of demand volatility (coefficient of variation) as a function of forecast accuracy for each product in a particular location (in this case the Supplier DC location). This information is useful for understanding the relationship between the forecasting performance and how volatile the demand is. Generally, a user may expect to see that the more volatile the demand, the more difficult it is to forecast the product's demand, although this may not be true in all cases. Similar plots may be provided for inventory days as a function of demand volatility, which can be used to show whether the pattern of inventory cover is linked to the volatility of the demand. Demand volatility may also be shown with and without events to show the extent to which events may be causing the demand volatility.

FIG. 29 illustrates an example of the demand event report, which is used to show whether there is any impact of events on demand volatility, inventory and forecasting. Various measures relating to demand volatility, forecast accuracy and forecast bias are output, calculated from input data relating to demand (FIG. 10) inventory (figure) and forecast (FIG. 11). A measure of demand volatility 2903, the coefficient of variation, is calculated for each location 2901 and each product 2902 using the mean and standard deviation of the demand data series (FIG. 10). A similar measure excluding events 2904 is calculated from the same input data but ignoring any weeks where an event is indicated (FIG. 12), and a difference in demand volatility 2905 determined. The measures of average inventory 2906 and average inventory excluding events 2907 are determined in a similar way from the inventory data (FIG. 8), and a difference 2908 determined. Measures of input forecast accuracy 2909 are derived from the input forecast data (FIG. 11) and input demand data (FIG. 10), with a further measure also taking into account forecast accuracy without events 2910 and a difference 2911 between the two measures calculated. A forecast bias 2912 is also calculated from the input forecast and input demand data, together with a bias without events 2913 and a difference measure 2914. Finally, uncapped forecast accuracy 2915 is calculated. For the other measures in the output, any forecast errors greater than 100% are discounted, i.e. errors are capped at 100% (and also cannot be less than zero). This is a common approach in measuring forecast errors. The uncapped forecast accuracy is a measure taken without this constraint, which allows a user to determine whether the capping is significantly affecting the calculations. This output report allows a detailed view of whether and by how much events are impacting demand volatility, inventory and forecasting; shading may be added to the table to highlight potential connections in the data. In the example, shading has been added to help highlight demand volatility 2903, difference in demand volatility 2905, average inventory 2906, difference in average inventory 2908, forecast accuracy 2909, forecast bias 2912, and uncapped forecast accuracy 2915.

A summary may be provided of all inputted and calculated measures relating to inventory values and warehousing costs, by each physical location, in the form of an inventory KPI hierarchy chart for each inventory warehouse location, an example of which is provided in FIG. 30. This summarizes various costs and targets and how these relate to each other hierarchically.

The various costs related to inventory at each location and for each product can also be illustrated in the form of a summary output report, an example of which is provided in FIG. 31. In this summary, the financial impact of inventory and inventory movement by product and physical location is shown. The report displays the average inventory quantity 3103, inventory value 3106, inventory storage cost 3107, warehouse handling cost 3108, and throughput 3104, 3105 of each product 3102 at each warehouse location 3101 plus the cost of transportation between modeled locations 3109 and the number of pallets moved 3110. Shading may be used to highlight particular values; in the example, shading has been applied to average inventory 3103, demand throughput 3104, inventory value 3106, inventory storage cost 3107, warehouse handling costs 3108, and transport costs 3110.

Various time series data is also plotted with event indicators for selected products and sequential locations in the supply chain, including forecast and demand data, inventory and inventory stock outs, and combinations of those. Examples are shown in FIGS. 32a and 32b of these plots.

The above described analysis provides a user with various options for investigating further into possible causes of issues within the supply chain being scrutinized, given the various outputs that can be generated automatically following data being input relating to the structure and operation of the supply chain. Further insights can also be obtained in an automated way through visual methods of presentation that are directed by the analysis results. FIG. 33 shows exemplary outputs from the root cause analysis. Generally, a root cause analysis output is provided for each location in the supply chain (although the example only shows two locations to illustrate the output). These outputs are in the form of root cause analysis trees/charts, providing the user with one or more issues relating to a particular location in the supply chain, what (if any) possible root causes have been identified for those issues using the input data provided, and a list of recommendations for the user to follow in investigating possible causes and addressing the issues.

In FIG. 34, a root cause analysis chain is shown for the ‘Uwh’ location, the identity of which is indicated in a first box 3301. Two issues have been found to affect various products at that location, high inventory 3302 and service below target 3305. First we follow the branch indicating an issue of high inventory has been identified, indicated by the box labeled ‘High Inventory’ 3302 connected to the first box 3301 with an arrow. The issue is identified for the products called ‘EventOverForecast’ and ‘OverForecast’ s (note that for convenience all the products in this root cause analysis example have been given names related to the issues), which have been determined to have an average inventory higher than the maximum target during 33% of the weeks in the defined period. This is a summary of the most relevant information from the inventory summary report in FIG. 24. No high inventory issues were identified for other products handled at the same location, however three other products were identified with service level issues, which is indicated by the box labeled ‘Service Below Target’ 3305 and a separate branch in the tree for the service issues. A box labeled ‘Possible Root Causes Found in Data’ 3303 is linked to the high inventory issues; within this box information is provided based on the input data as to whether there is supporting evidence in that data for root causes or contributory factors for the issue. In the example, the box 3303 contains information that indicates there was evidence for a root cause of over-forecasting events was found for the product called ‘EventOverForecast’ and negative forecast bias was found to be a contributory factor for the product called ‘OverForecast’. The box contains calculated outputs from assess the evidence for the root causes or contributory factors; in the example over-forecasting of events is estimated to have added 44.8 days of excess inventory to that location, and forecast bias of −20.1% was deemed significant in contributing to high inventory through over-forecasting. A box labeled ‘RCA High Stock Checklist’ 33094 is provided, linked to the second box 3303 by an arrow to indicate that there are a number of recommendations for the user in resolving and investigating this type of high inventory issue. These recommendations are summarized as:
1. Stock build for a planned event (e.g., launch, promotion).
2. Stock build for an expected supply problem (e.g., industrial action, facility changes).
3. Over supply with stock pushed from supplying site.
4. Over-forecasting (negative bias) accumulated excess stock.
5. Minimum shipment/order quantity that is equivalent to many days of stock.
6. Unexpected fall in sales caused by other products (cannibalisation).
7. Sales lower than expected because of competitor's activities.
8. Re-balancing inventory brought-in additional stock from the distribution network.
9. Inventory accuracy issue; under-estimated actual stock holding.
10. Cancelled export order or other unexpected demand adjustment.
11. Accumulated stock from forward buying for an offer or contract.
12. Inventory build for seasonal item.
13. Changes in inventory management approach or personnel.
14. End-of-quarter effects led to excess stock.
15. Warehouse management issues.

Each of the above items indicates to the user a possible cause of high inventory in the location in question. It is then up to the user to follow up on one or more of these recommendations by investigating further and determining for example whether the issue is one that needs to be resolved.

Second, we follow the branch indicating service issues with the box labeled ‘Service Below Target’ 3305; which indicates 3 products have service issues, the products called ‘EventUnderForecast’, ‘UnderForecast’, and ‘PolicyWrong’. The box labeled ‘Possible Root Causes Found in Data’ 3306 indicates that evidence has been found for two root causes and two contributory factors for the products with lower than expected service. The inventory policy alignment is a root cause of low service for the product called ‘WrongPolicy’ and the calculation from the input data suggests the stated inventory policy with minimum cover of 3 days is too low because the calculation suggests this should be at least 4.3 days. Under-forecasting of events is a root cause of low service for the product called ‘EventUnderForecast’ and calculations suggest this has caused a stock shortage of 1470 cases and reduced inventory adversely by 36.1 days. Two contributory factors were found for the product called ‘UnderForecast’, under-forecasting a manufacturing event (which leads to stock out of 100 cases or 3.1 days of inventory) and positive forecast bias of 25.1%); with neither effect being judged quite strong enough to be a sole root cause of low service.

In the box labeled ‘RCA Low Service Checklist’ 3307, a low service checklist is provided relating to the issue of service being below target, which provides the following recommendations for the user to investigate further:
1. Stock depleted by a planned event (e.g., launch, promotion).
2. Supply reliability issue (e.g., industrial action, capacity constraint).
3. Under-forecasting (positive bias) depleted stock.
4. Unexpected rise in sales (e.g., higher seasonal peak).
5. Inventory accuracy issue; over-estimated actual stock holding.
6. Stock re-deployed to another location leaving shortfall.
7. End-of-quarter effects depleted stock.
8. Item requiring specialized storage; constraint on space, limited stock.
9. Issue in deployment planning; replenished later than expected.
10. Misaligned inventory policy; holding insufficient stock.
11. Missing an event in the forecast (e.g., promotion).
12. Delays in movement in/out of the warehouse because of access issues.
13. Warehouse management issues.

FIG. 33 also illustrates a root cause analysis for the Store location (box 3308). In this case, an issue relating to shelf availability being below target (box 3309) has been identified for three products called ‘StoreServiceLow’, ‘StoreUnderForecast’, and ‘StoreShelfRepl’. The following possible root causes (box 3310) are identified:

Possible Root Causes Found in Data

Event under-forecasting:

StoreUnderForecast: ROOT CAUSE

Found 1 event; Stock out 280 (Cases).

Stock impact 11.6 days.

Shelf replenishment:

StoreServiceLow: Shelf avail. 89.0%<store fill rate 93.5%.

StoreUnderForecast: Shelf avail. 89.0%<store fill rate 89.2%.

StoreShelfRepl: Shelf avail. 89.0%<store fill rate 93.5%.

Store replenishment:

<StoreServiceLow>: store replenishment fill rate 93.5%.

<StoreUnderForecast>: store replenishment fill rate 89.2%.

<StoreShelfRepl>: store replenishment fill rate 93.5%.

One possible root cause is identified, being event under-forecasting for the product called ‘StoreUnderForecast’, and two contributory factors are identified as shelf replenishment and store replenishment affecting all three products. In the case of event under-forecasting a possible root cause is supported by evidence that suggests the under-forecasting led to a stock out of 280 cases or 11.6 days of inventory. Shelf replenishment issues are indicated for the three products because the shelf availability is less than the service fill rate to the store, indicating that store operations replenishing the shelf are likely to be contributing to service issues. Finally, the store replenishment service level is below target, indicating the inbound service to the store will also be contributing to lower than expected service levels.

A low service checklist labeled ‘RCA Store Low Service Checklist’ (box 3311) is provided for the user to investigate further into the actual causes of the issue identified, which includes:
1. Store replenishment processes.
2. Shelf replenishment processes.
3. Shelf space insufficient for sales rate.
4. Stock space restrictions in backroom; unable to handle demand variability.
5. Store forecasting of an event (e.g., launch, promotion).
6. Insufficient backroom space for event stock requirements.
7. Forecast bias (positive); under-estimating demand.
8. Frequency of store replenishment deliveries.
9. Delays in store delivery.
10. Store inventory accuracy issue; over-estimated actual stock.
11. Unexpected rise in sales (i.e., upward trend).
12. Issues with store ordering/management processes.

In summary, the invention disclosed herein provides for an automated system in which a process flow in a supply chain context can be analyzed and measures of operation of the supply chain determined. Based on one or more of the series of measures being outside a predefined range, the system is able to generate an output indicating recommendations for adjusting operation of the supply chain. A customized recommendation is output relating to one or more of: i) an inventory level for one or more of the products being above a defined threshold for the defined period; ii) a service level for one or more of the products being below a defined threshold for the defined period; iii) a level of shelf availability for one or more of the products being below a defined threshold; and iv) a level of responsiveness for one or more of the products being delivered at the optimum threshold. Such recommendations may be provided in the form of root cause analysis charts as described above, which are particularly advantageous for users being less familiar with the type of detailed analysis required to identify possible root causes and actions from the measures alone.

An exemplary flow chart outlining the method according to an aspect of the invention is illustrated in FIG. 34. The process starts (step 3401) and a first set of data is input (step 3402), the first set of data describing the configuration and structure of the supply chain being analyzed. This data may be input automatically, for example by being extracted from a pre-prepared data store, or may be input manually. A data array is then generated based on the first set of data (step 3403), into which data relating to the operation of the supply chain can be entered. This data relating to the operation of the supply chain is then input as a second set of data (step 3404), which again may be provided automatically from a data store or input manually. Once the second set of data is input, a series of measures is calculated (step 3405) based on the second set of data. From this series of measures recommendations are generated (step 3406), and the process then ends (step 3407). The recommendations allow the user to analyze possible issues relating to operation of the supply chain.

A method according to the invention will typically be implemented by an application on a processor in conjunction with a memory, for example on a personal computer. An exemplary computer system is illustrated schematically in FIG. 35. The system comprises a processor 3501, a memory 3502, an output device 3503 such as a display or printer and an input device 3504 such as a keyboard or mouse. Each of these components 3501, 3502, 3503, 3504 is connected via a bus 3505 to allow the components to communicate with each other.

A schematic diagram of an exemplary arrangement of the application residing on the computerized system of FIG. 34 is illustrated in FIG. 35. The application may be partly or wholly implemented on the processor 3601 of the computer system. Part of the application may be provided on the memory 3602, which may be a data store on the computer system or otherwise accessible by the processor 3601. The main functional components of the application are an array generator 3601 and a calculating module 3602. The array generator 3601 takes a first data array 3603 into which a first set of data 3604 has been input and generates a second data array 3605. A second set of data 3606 is entered into the second data array 3605 for the calculating module 3602 to process. The calculating module 3602 processes the second set of data 3605 and generates a series of output measures 3607 and a series of output recommendations 3608 based on the measures 3607. Further modules may be provided as part of the application to carry out functions such as displaying the measures and recommendations on the output device 3503 for being viewed by a user. The first and second sets of data 3604, 3606 may be provided on a data store accessible by the application, for example an external memory, hard drive or networked store. A user may access the application directly on a computer or alternatively may access the application remotely, in the case where the application is being executed on a remote networked computer.

Other embodiments are intended to be within the scope of the invention, which is defined by the appended claims.

1. A method of analyzing a process flow in a supply chain context, the method comprising:
inputting a first set of data to an application residing on a processor, the first set of data relating to a plurality of different products, a plurality of different locations and a plurality of supply routes connecting the different locations in the supply chain along which the plurality of products are distributed;
the application generating from the first set of data an input data array having dimensions corresponding to the plurality of products, locations and supply routes;
inputting into the input data array a second set of data relating to measured and forecast flows of the different products through the supply chain over a defined time period;
the application calculating from the second set of data a series of measures of operation of the supply chain; and
based on one or more of the series of measures being outside a predefined range, the application generating an output indicating recommendations for adjusting operation of the supply chain.

2. The method of claim 1 wherein the series of measures includes for each of the plurality of different products at each of the plurality of different locations one or more of:
a measure of volatility in demand;
a measure of average inventory;
a measure of forecast accuracy; and
a measure of forecast bias.

3. The method of claim 1 or claim 2 wherein the series of measures take into account the effect of including one or more events within the defined time period.

4. The method of claim 3 wherein the one or more events comprise a promotional event relating to one or more of the plurality of products.

5. The method of claim 1 wherein the application performs analysis of the second set of data for each of the plurality of locations and outputs a customized recommendation relating to any of the series of measures being outside a predefined bound for each location.

6. The method of claim 5 wherein the application outputs a customized recommendation relating to one or more of:
an inventory level for one or more of the products being above a defined threshold for the defined period;
a service level for one or more of the products being below a defined threshold for the defined period;
a level of shelf availability for one or more of the products being below a defined threshold; and
a level of responsiveness for one or more of the products being delivered at the optimum threshold.

7. The method of claim 5 wherein the application outputs one or more potential causes for the series of measures being outside the predefined bound.

8. The method of claim 6 or claim 7 wherein the customized recommendation comprises a predefined checklist specific to an associated measure being outside the defined bound.

9. A method of analyzing a process flow in a supply chain context, the supply chain comprising a plurality of different products flowing between a plurality of different locations connected by a plurality of supply routes, the method comprising:
inputting a set of data to an application residing on a processor, the set of data relating to measured and forecast flows of the different products through the supply chain over a defined time period;
the application calculating from the input set of data a series of measures of operation of the supply chain; and
based on one or more of the series of measures being outside a predefined range, the application generating an output indicating recommendations for adjusting operation of the supply chain.

10. A method of visualizing a process flow in a supply chain context, the method comprising:
providing data relating to a plurality of different products in the supply chain, the data relating to inventory levels and process flow timings associated with a plurality of locations in the supply chain;
selecting one of the plurality of different products; and
generating a graphical representation of data relating to the selected product, the graphical representation comprising a timeline indicating the inventory levels and process timings for the selected product at each of the plurality of locations in the supply chain.

11. The method of claim 10 wherein the step of providing data comprises sampling product data from a larger data set representing a product portfolio.

12. The method of claim 10 wherein the supply chain includes a plurality of parallel processes, the inventory levels and process timings for each of the parallel processes being displayed in the graphical representation.

13. The method of claim 10 wherein the step of providing data comprises taking a sample of data relating to the plurality of products in the supply chain.

14. The method of claim 13 comprising generating a report relating to the sample of data, wherein entries in the report are indicated relative to a predefined range.

15. The method of claim 14 wherein entries in the report outside a predefined range are highlighted.

16. The method of claim 10 comprising presenting a graphical representation of inventory levels for one or more of the plurality of locations in the supply chain over a defined sampling period.

17. The method of claim 16 wherein the graphical representation indicates predefined maximum and/or minimum inventory levels over the defined sampling period.

18. A system for analyzing a process flow in a supply chain context, the system comprising an application residing on a processor and a memory, the system comprising:
a first input data array having a first set of data relating to a plurality of different products, a plurality of different locations and a plurality of supply routes connecting the different locations in the supply chain along which the plurality of products are distributed;
a data array generator configured to generate from the first set of data a second input data array having dimensions corresponding to the plurality of products, locations and supply routes in the first set of data; and
a calculating module configured to input into the second input data array a second set of data relating to measured and forecast flows of the different products through the supply chain over a defined time period, calculate from the second set of data a series of measures of operation of the supply chain and, based on one or more of the series of measures being outside a predefined range, generate an output indicating recommendations for adjusting operation of the supply chain.
